(19) United States
(12) Patent Application Publication
(10) Pub. No.: US 2023/0391622 A1
(43) Pub. Date: Dec. 7, 2023

(54) METHODS FOR FABRICATING GRAPHENE NANORIBBONS

(71) Applicant: THE UNIVERSITY OF CHICAGO, Chicago, IL (US)

(72) Inventors: Guangbin Dong, Chicago, IL (US); Jiangliang Yin, Chicago, IL (US); Daniel Pyle, Chicago, IL (US)

(21) Appl. No.: 18/206,235

(22) Filed: Jun. 6, 2023

Related U.S. Application Data
(60) Provisional application No. 63/349,811, filed on Jun. 7, 2022.

(51) Int. Cl. C01B 32/15

(52) U.S. Cl. CPC C01B 32/15; C01P 2004/04; C01P 2004/17

(57) ABSTRACT

Provided are methods for fabricating a graphene nanoribbon (GNR). The methods comprise performing, n times, a protecting-group-aided iterative synthesis (PAIS) step; performing, m times, an iterative binomial synthesis (IBS) step; or both; cross-coupling a final deprotected polyarene intermediate with an endcapper to form a GNR precursor; and subjecting the GNR precursor to conditions to induce cyclodehydrogenation to form a GNR.

### CROSS-REFERENCE TO RELATED APPLICATIONS

The present application claims priority to U.S. provisional patent application No. 63/349,811 that was filed Jun. 7, 2022, the entire contents of which are incorporated herein by reference.

### REFERENCE TO GOVERNMENT RIGHTS

This invention was made with government support under N00014-19-1-2596 awarded by the Office of Naval Research. The government has certain rights in the invention.

### BACKGROUND

Graphene nanoribbons (GNRs) have recently attracted much attention because of their versatile electronic, optical, and magnetic properties. This gives them potential for impactful future nanoelectronic, spintronic, photonic, sensing, quantum information processing, and energy conversion applications. The physical behavior of GNRs is dictated by their precise structure, which, in principle, may be tuned by altering parameters such as length, width, heteroatom doping, edge structure, and defect incorporation.

### SUMMARY

Although several techniques have been developed for synthesizing GNRs, no existing technique is able to provide monodisperse GNRs having well-defined lengths or well-defined heterogeneous monomer sequences. The present disclosure describes methods that provide direct access to structurally diverse, perfectly sequenced, and monodisperse “designer” GNRs. This is one of the holy grails of the GNR field.

The present methods involve one or more protecting-group-aided iterative synthesis (PAIS) steps, one or more iterative binomial synthesis (IBS) steps, or combinations thereof. In embodiments, a method of fabricating a GNR comprises performing, n times, a protecting-group-aided iterative synthesis (PAIS) step; performing, m times, an iterative binomial synthesis (IBS) step; or both; cross-coupling a final deprotected polyarene intermediate with an endcapper to form a GNR precursor; and subjecting the GNR precursor to conditions to induce cyclodehydrogenation therein to form a GNR. The PAIS step comprises cross-coupling an aryl boronic acid with a bifunctional building block (BBB), the BBB comprising a halide moiety or a phenyl triflate moiety; an aryl moiety; and a protected boronic acid moiety, under conditions to form a protected polyarene intermediate; and deprotecting the protected polyarene intermediate to form a deprotected polyarene intermediate. The IBS step comprises subjecting a first portion of a phenol-substituted bifunctional oligomer segment (BOS), the phenol-substituted BOS comprising a phenol moiety, an aryl moiety, and a protected boronic acid moiety, to deprotection to form a phenol-substituted aryl boronic acid; subjecting a second portion of the phenol-substituted BOS to triflation to provide a phenyl triflate-substituted BOS comprising a phenyl triflate moiety; the aryl moiety; and the protected boronic acid moiety; and cross-coupling the phenol-substituted aryl boronic acid and the phenyl triflate-substituted BOS to form a protected, phenol-substituted polyarene intermediate.

Systems configured to carry out the disclosed methods are also provided. Compositions comprising the GNR precursors or the GNRs are also provided.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1A shows a new programmable fabrication strategy for obtaining structurally diverse and monodisperse “designer” GNRs based on protecting-group-aided iterative synthesis (PAIS). The 1,8-diaminonapththalene boryl [B(dan)] moiety, a protected form of boronic acid, is shown in the bottom left. FIG. 1B shows that in this PAIS process, the Suzuki-Miyaura coupling (SMC) and B(dan) deprotection constitute one operative iteration, and only one GNR monomer is introduced to the chain per iteration.

FIGS. 2A-2D illustrate the fabrication of chGNR(6), demonstrating length control achieved by the present methods. FIG. 2A shows synthesis of the oligomer GNR precursor pre-chGNR(6). Yields for each iteration in the oligomer synthesis are provided at the corresponding connecting positions. FIG. 2B shows a BRSTM image (constant height dI/dV at V=0V) of chGNR(6). FIG. 2C shows a large-scale STM topograph (V=−1.8V, I=50 pA) showing monodisperse chGNR(6) on Au(111) after CDH step. FIG. 2D shows MALDI-TOF-MS spectra of pre-chGNR(6), further establishing the monodispersity achieved by the present methods.

FIGS. 3A-3F illustrate the fabrication of 9-chGNRs, demonstrating heterostructure control achieved by the present methods. FIG. 3A shows synthesis of the oligomer GNR precursor pre-9-chGNR demonstrating a precise two-component GNR heterostructure. Yields for each iteration in the oligomer synthesis are provided at the corresponding connecting positions. FIG. 3B shows a BRSTM image (constant height dI/dV at V=0V) of 9-chGNR after CDH. FIGS. 3C, 3D show BRSTM images (constant height dI/dV at V=0V) of 9-chGNRs showing phenyl ejection defects. FIG. 3E shows a large-scale STM topograph (V=−0.8V, I=50 pA) showing monodisperse 9-chGNRs on Au(111). FIG. 3F shows MALDI-TOF-MS spectra of pre-9-chGNR, further establishing the monodispersity achieved by the present methods.

FIGS. 4A-4C illustrate the fabrication of double heterojunction 6/9/6-AGNRs. FIG. 4A shows synthesis of oligomer GNR precursor pre-6/9/6-AGNR demonstrating a 6/9/6 double heterojunction. Yields for each iteration in the oligomer synthesis are provided at the corresponding connecting positions. The inset shows MALDI-TOF-MS spectra of pre-6/9/6-AGNR. FIG. 4B shows a largescale STM topograph (V=−2V, I=50 pA) of monodisperse oligomer GNR precursor (pre-6/9/6-AGNRs). The inset shows a close-up scan (V=−1.8V, I==50 pA) of two precursors, including structure overlay. FIG. 4C shows BRSTM images (constant height dI/dV at V=0V) of 6/9/6-AGNRs after CDH. Flip defects can be seen in different isomers structures.

FIGS. 5A-5D illustrate the fabrication of kinked GNRs: 6-V-6-AGNRs. FIG. 5A shows synthesis of oligomer GNR precursor pre-6-V-6-AGNR demonstrating a kinked GNR structure. Yields for each iteration in the oligomer synthesis are provided at the corresponding connecting positions. The inset shows MALDI-TOF-MS spectra of pre-6-V-6-AGNRs. FIG. 5B shows a STM topograph (V=−1.4V, I=100 pA) of oligomer GNR precursor (pre-6-V-6-AGNR). FIG. 5C shows a large-scale STM topograph (V=−1.6V, I=50 pA) showing monodisperse 6-V-6-AGNRs after CDH. FIG. 5D shows BRSTM images (constant height dI/dV at V=0V) of 6-V-6-AGNRs; flip defects are visible in the isomer structures.

FIGS. 6A-6E illustrate the fabrication of a GNR with kinked heterojunctions: 9-V-chGNRs. FIG. 6A shows synthesis of oligomer GNR precursor pre-9-VchGNR demonstrating a kinked, two-component GNR heterostructure. Yields for each iteration in the oligomer synthesis are provided at the corresponding connecting positions. The inset shows MALDI-TOF-MS spectra of pre-9-V-chGNR. FIG. 6B shows a large-scale STM topograph (V=−2V, I=50 pA) of oligomer GNR precursor (pre-9-V-chGNRs). FIG. 6C shows a close-up STM image (V=−2V, I=50 pA) of pre-9-V-chGNR (boxed area in FIG. 6B). FIG. 6D shows a large-scale STM topograph (V=−1.8V, I=50 pA) of monodisperse 9-V-chGNRs after CDH (each GNR is labeled by a circle). FIG. 6E shows BRSTM images (constant height dI/dV at V=0V) of 9-V-chGNRs; bite defects can be seen.

FIG. 7 shows five bifunctional building blocks (BBB). A synthetic route to such BBBs is also shown, illustrated using BBBₚₚₕ.

FIG. 8 shows one operative iteration of PAIS (i.e., a single PAIS step), illustrated by reference to phenylboronic acid and BBBₚₚₕ.

FIG. 9 shows a synthetic route to BBBs and derivatives thereof, illustrated using BBBₚₚₕ.

FIG. 10 illustrates integrated iterative binomial synthesis (IIBS) strategy which merges PAIS and iterative binomial synthesis (IBS).

FIG. 11A illustrates the IBS strategy to form a monodisperse GNR precursor with phenylene and ortho-terphenylene units. FIG. 11B illustrates the IIBS strategy to form long kinked monodisperse polyphenylenes with a controlled sequence and unusual topology. FIG. 11C shows MALDI-TOF-MS spectra of BOS2-17, BOS2-34, BOS2-68 and BOS2-136. FIG. 11D shows GPC traces of BOS2-34, BOS2-68 and BOS2-136.

FIGS. 12A-12C show the details of a synthetic route to various bifunctional oligomer segments (BOS1-1 to BOS1-32).

FIGS. 13A-13D show the details of a synthetic route to various bifunctional oligomer segments (BOS2-9 to BOS2-136).

### DETAILED DESCRIPTION

Provided are methods for fabricating a graphene nanoribbon (GNR). The methods comprise performing, n times, a protecting-group-aided iterative synthesis (PAIS) step; performing, m times, an iterative binomial synthesis (IBS) step; or both; cross-coupling a final deprotected polyarene intermediate with an endcapper to form a GNR precursor; and subjecting the GNR precursor to conditions to induce cyclodehydrogenation to form a GNR. In the methods, “n” and “m” are independently selected integers. In embodiments, n is in a range of from 1 to 100, from 1 to 75, from 1 to 50, or from 1 to 25. In embodiments, m is in a range of from 1 to 10, 1 to 8, or 1 to 6.

A PAIS step may comprise a substep (i), cross-coupling an aryl boronic acid with a bifunctional building block (BBB), the BBB comprising a halide moiety or a phenyl triflate moiety; an aryl moiety; and a protected boronic acid moiety, under conditions to form a protected polyarene intermediate; and a substep (ii), deprotecting the protected polyarene intermediate to form a deprotected polyarene intermediate. A BBB comprising a halide moiety may also be referred to as a halide BBB and a BBB comprising a phenyl triflate moiety may be referred to as a triflated BBB. “Cross-coupling” refers to solution-mediated cross-coupling as described in the Examples, below, using conditions to induce carbon-carbon bond formation between respective aryl moieties of the coupling partners (e.g., here, the aryl boronic acid and the BBB). Illustrative such conditions are provided in the Examples, below. “Deprotection” refers to the removal of a protecting group from the protected boronic acid as described in the Examples, below, using conditions to induce hydrolysis of the protected boronic acid. Illustrative such conditions are also provided in the Examples, below. As noted above, the PAIS step may be carried out once (i.e., n=1), twice (i.e., n=2), . . . up to n times. The cross-coupling conditions and the deprotection conditions of any PAIS step may be the same or different as those used in any other PAIS step.

In an initial PAIS step (i.e., n=1) the aryl boronic acid may be referred to as an initiator. The aryl boronic acid (including the initiator) comprises an aryl moiety and a boronic acid moiety. As noted above, the cross-coupling partner is a BBB comprising either a halide moiety or a phenyl triflate moiety; an aryl moiety; and a protected boronic acid moiety. The cross-coupling induces carbon-carbon bond formation between the aryl moiety of the aryl boronic acid and the aryl moiety of the BBB to form a protected polyarene intermediate, which is deprotected to form a deprotected polyarene intermediate.

Subsequent PAIS steps (e.g., n=2) comprise using the deprotected polyarene intermediate formed from a previous PAIS step (e.g., n=1) as the aryl boronic acid and another BBB (which may be the same or different as used in the previous PAIS step) to form another protected polyarene intermediate, which is deprotected to form another deprotected polyarene intermediate.

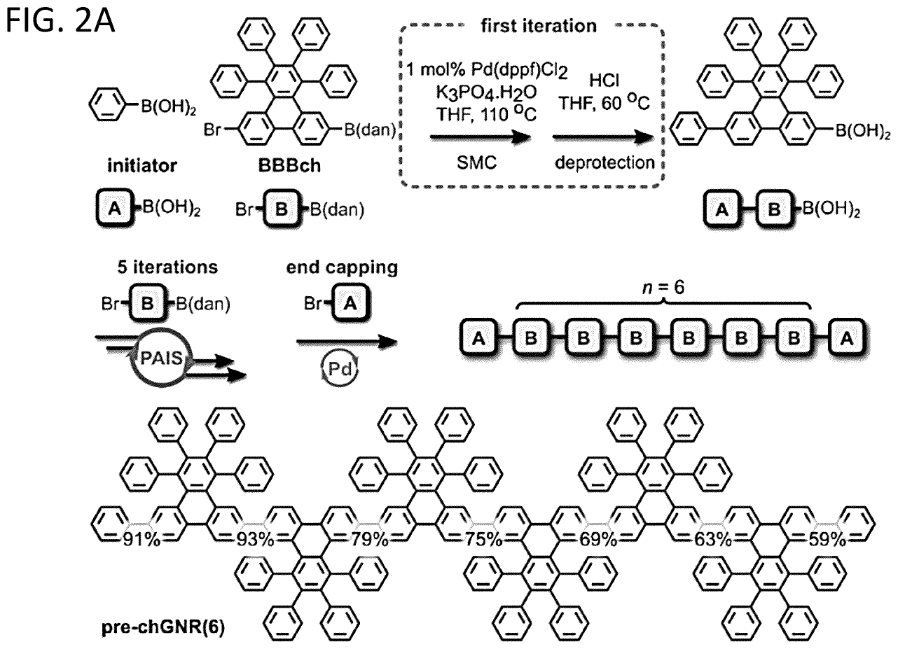

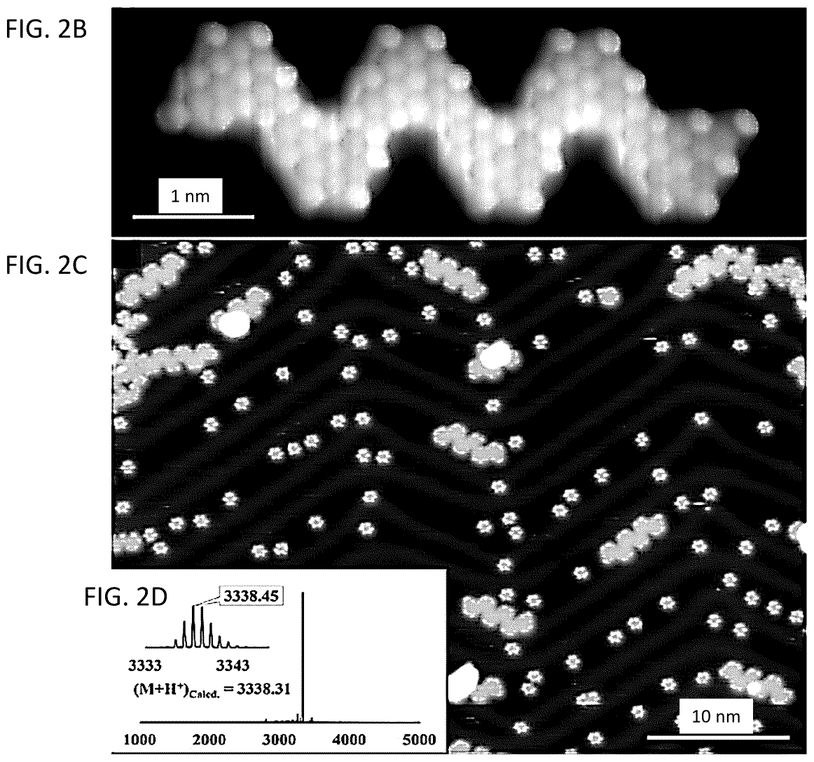

By way of illustration and in reference to FIG. 2A, an initial PAIS step uses “A-B(OH)₂” as an initial aryl boronic acid (“initiator”) and “BBBch” as an initial BBB to form “A-B-B(OH)₂” (after deprotection) as an initial, or first, deprotected polyarene intermediate. A second PAIS step uses “A-B-B(OH)₂” from the initial PAIS step as the aryl boronic acid and another “BBBch” as the BBB to provide “A-B-B-B(OH)₂” (after deprotection) as a second deprotected polyarene intermediate. A third PAIS step uses “A-B-B-B(OH)₂” from the second PAIS step as the aryl boronic acid and another “BBBch” as the BBB to provide “A-B-B-B-B(OH)₂” (after deprotection) as the third deprotected polyarene intermediate, etc. This method is further described in Example 1, below.

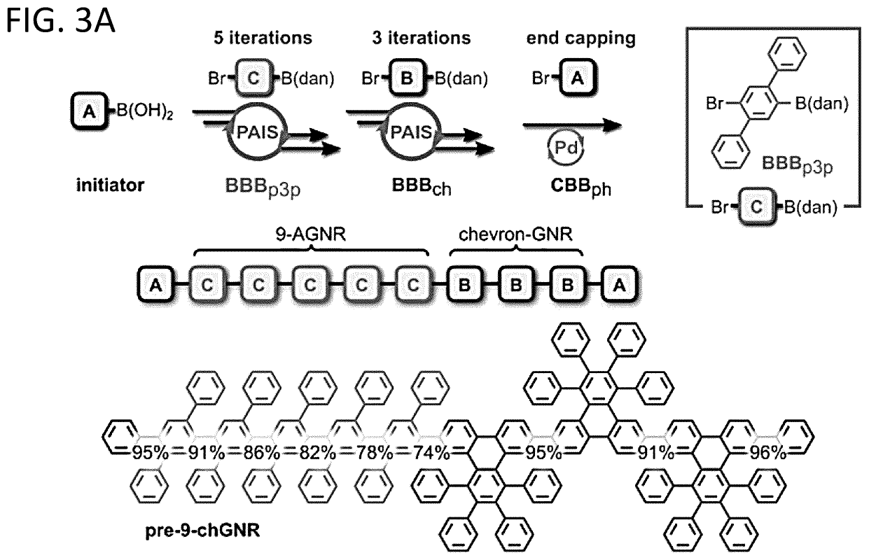

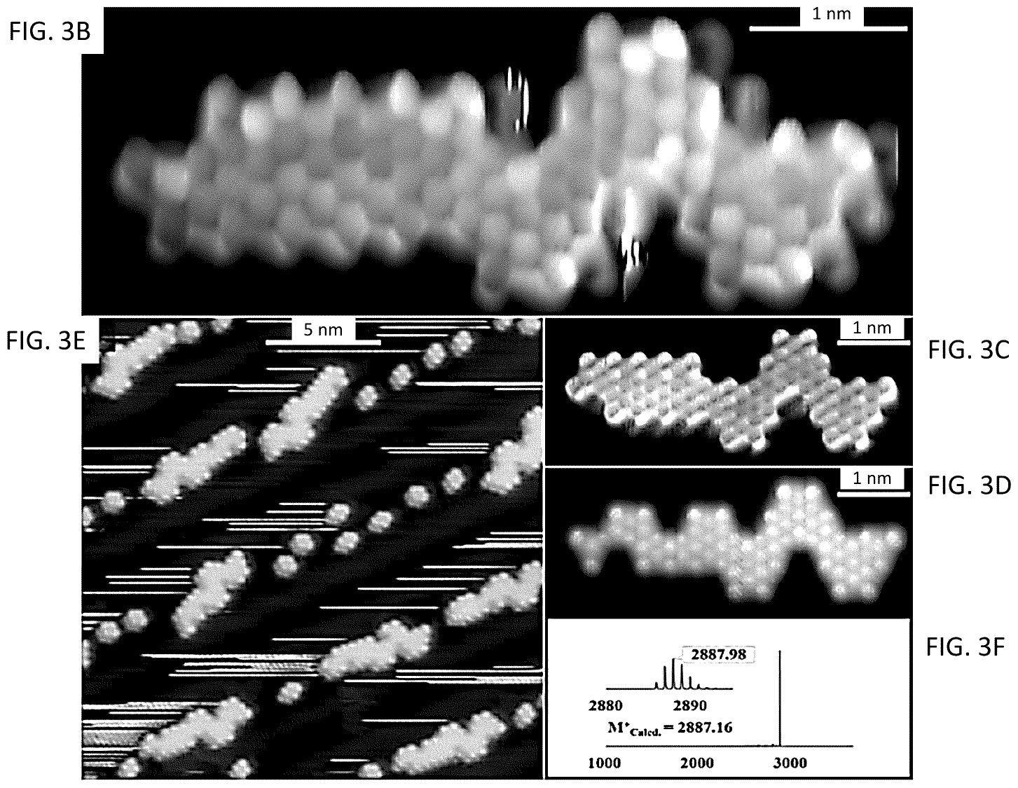

Other illustrative PAIS steps are shown in FIGS. 3A, 4A, 5A, and 6A, which are each further described in Example 1, below.

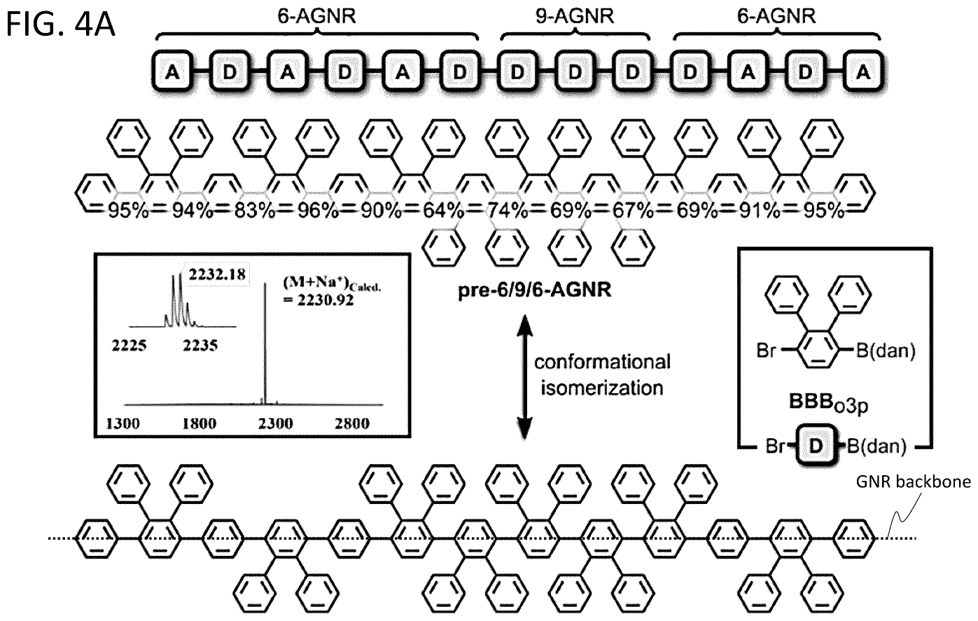

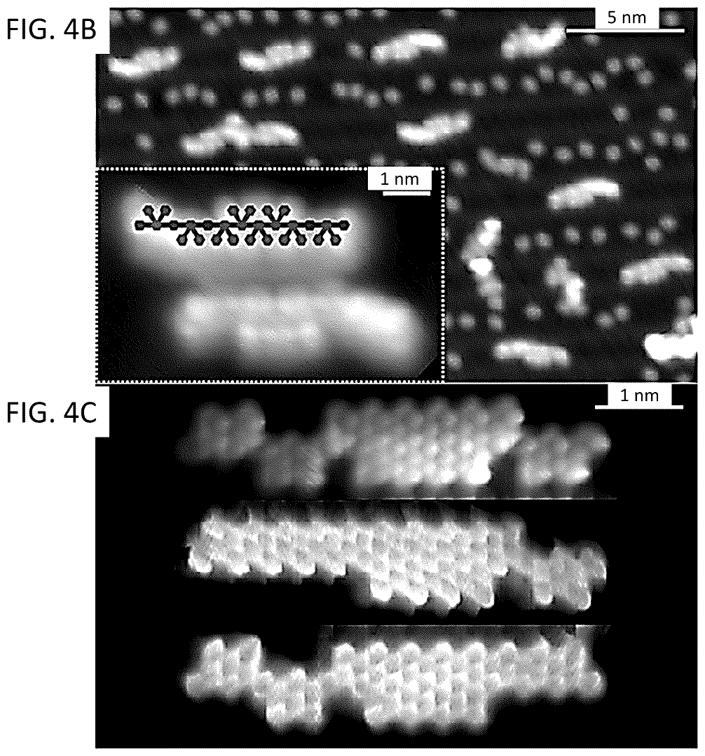

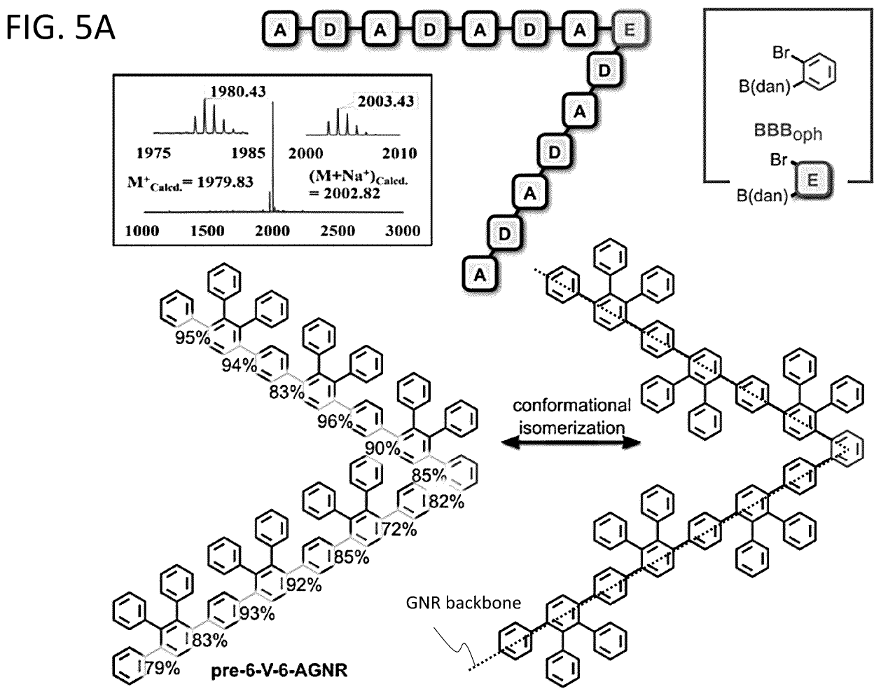

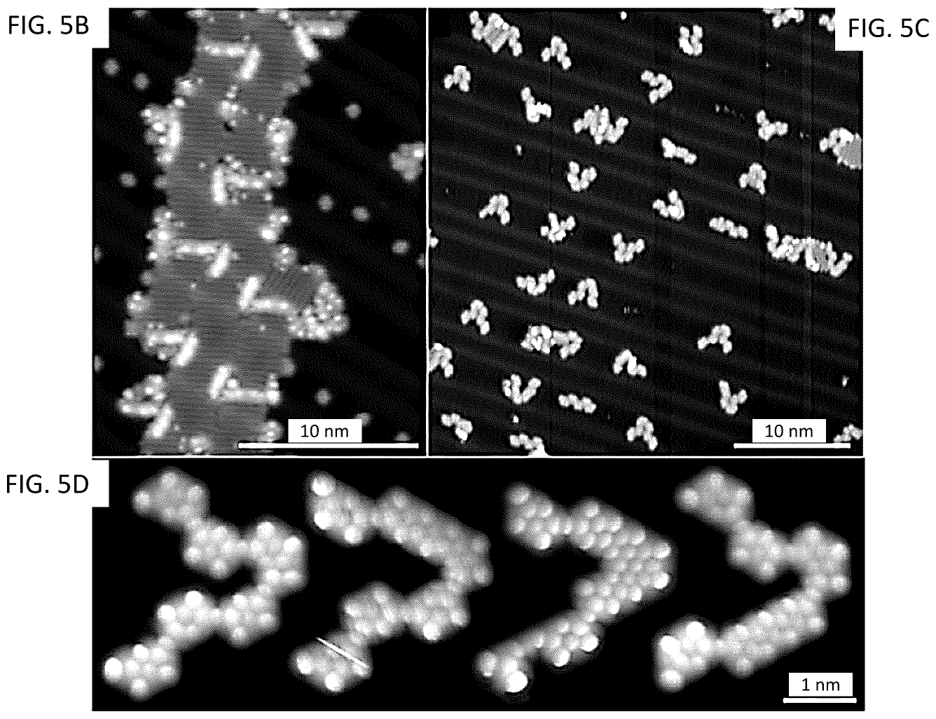

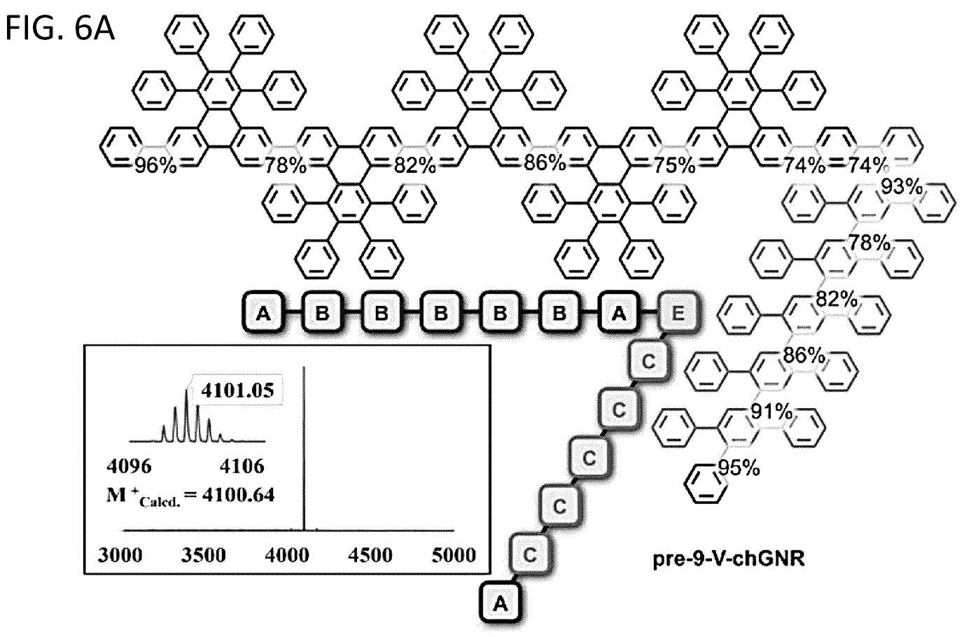

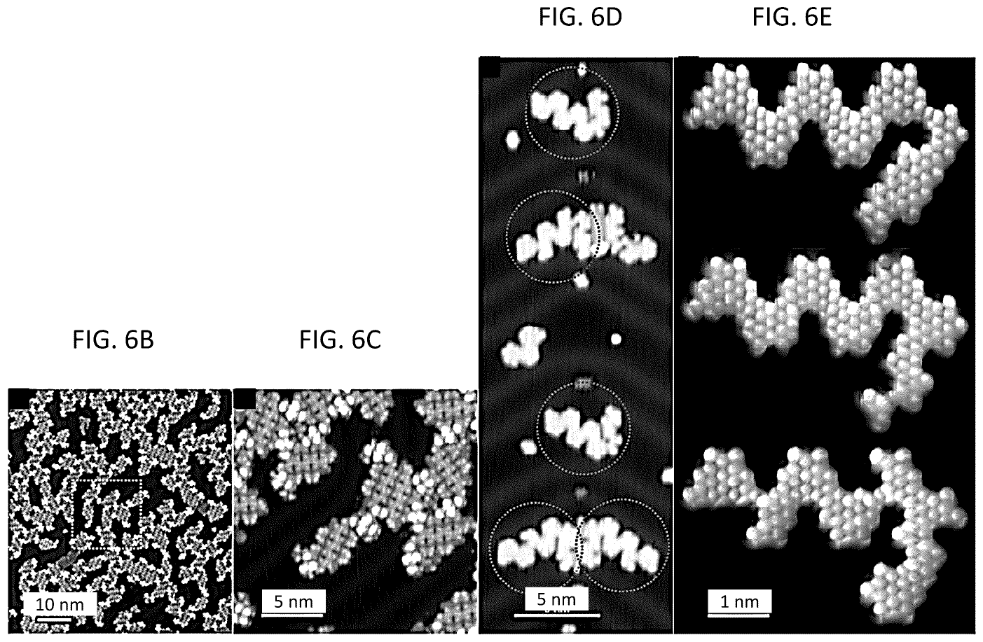

As noted above, the present methods further comprise cross-coupling a final deprotected polyarene intermediate with an endcapper to form a GNR precursor. The final deprotected polyarene intermediate may be the n^{th} deprotected polyarene intermediate from the n^{th} i.e., final, PAIS step. The endcapper may comprise an aryl moiety and a halide moiety. The cross-coupling may be carried out as described above with respect to the PAIS steps. Illustrative GNR precursors are shown in FIG. 2A (“pre-chGNR(6)”), FIG. 3A (“pre-9-chGNR”), FIG. 4A (“pre-6/9/6-AGNR”), FIG. 5A (“pre-6-V-6-AGNR”), and FIG. 6A (“pre-9-V-chGNR”). GNR precursors may be referred to as “oligomer GNR precursors” (and similar terms) in Example 1, below.

In order to convert a GNR precursor to the desired GNR, the present methods further comprise subjecting the GNR precursor to conditions to induce cyclodehydrogenation therein to form a GNR. “Cyclodehydrogenation” refers to formation of covalent bonds between neighboring phenyl moieties in the GNR precursor, with the accompanying elimination of hydrogen. Thus, cyclodehydrogenation causes the GNR precursors to become “cyclized” and thus, conjugated, to form the GNRs. Various cyclodehydrogenation techniques may be used, e.g., surface-assisted cyclodehydrogenation and solution-mediated cyclodehydrogenation. In embodiments, surface-assisted cyclodehydrogenation is used. Illustrative conditions and details for carrying out surface-assisted cyclodehydrogenation are provided in Example 1, below.

FIGS. 2B-2C show STM images of GNRs (“chGNR6”) formed by subjecting the corresponding GNR precursors (“pre-chGNR(6)”) to surface-assisted cyclodehydrogenation. Other illustrative GNRs are shown in the STM images of FIGS. 3B-3C (“9-chGNR”), 4B-4C (“6/9/6-AGNR”), 5B-5C (“6-V-6-AGNR”), and 6B-6C (“9-V-chGNR”).

An IBS step may comprise a substep (iii), subjecting a first portion of a phenol-substituted bifunctional oligomer segment (BOS), the phenol-substituted BOS comprising a phenol moiety, an aryl moiety, and a protected boronic acid moiety, to deprotection to form a phenol-substituted aryl boronic acid; a substep (iv), subjecting a second portion of the phenol-substituted BOS to triflation to provide a phenyl triflate-substituted BOS comprising a phenyl triflate moiety; the aryl moiety; and the protected boronic acid moiety; and a substep (v), cross-coupling the phenol-substituted aryl boronic acid and the phenyl triflate-substituted BOS to form a protected, phenol-substituted polyarene intermediate. In the IBS steps, the cross-coupling and deprotection may be carried out as described above with respect to the PAIS steps. Illustrative cross-coupling/deprotection conditions used in IBS steps are also provided in the Example 2, below. “Triflation” refers to the chemical conversion of a hydroxyl moiety to a triflate moiety using conditions as described in Example 2, below. As noted above, the IBS step may be carried out once (i.e., m=1), twice (i.e., m=2), . . . up to m times. The deprotection conditions, triflation conditions, and cross-coupling conditions in any IBS step may be the same or different as those used in any other IBS step.

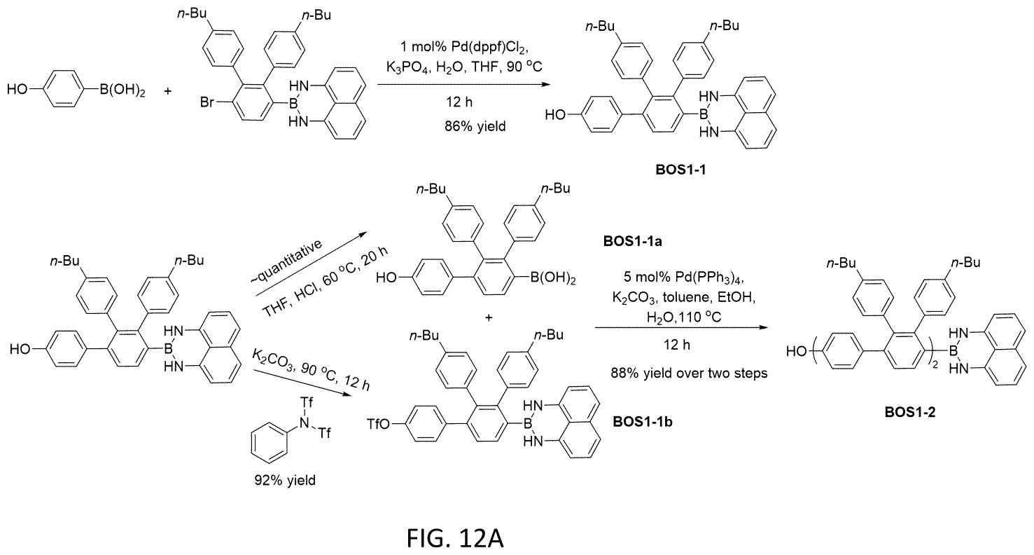

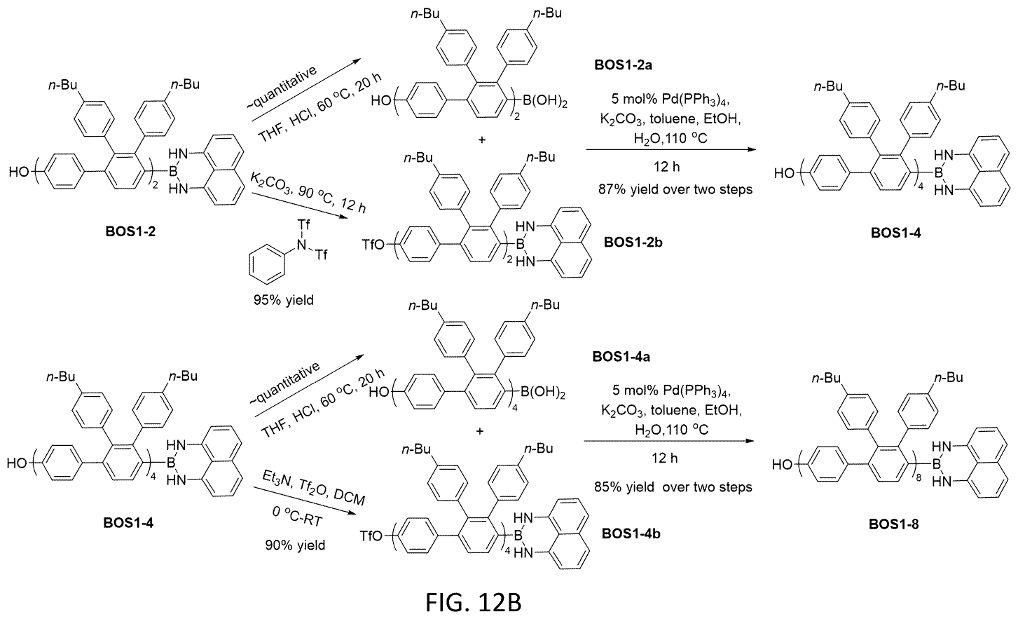

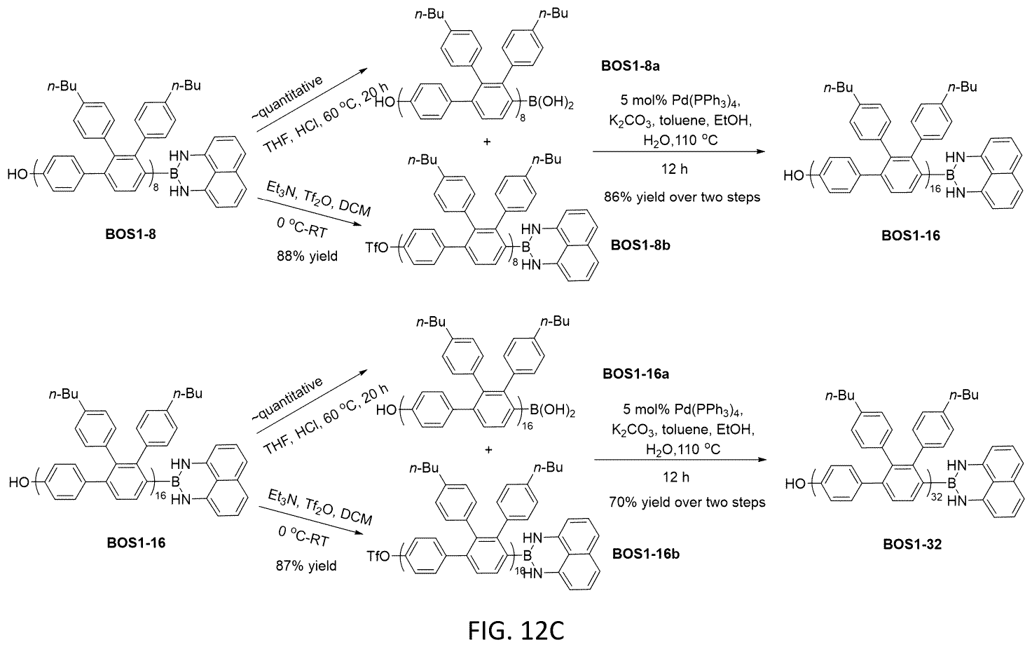

In an initial IBS step (i.e., m=1), the phenol-substituted BOS may be referred to as an initiator BOS, which may be formed by cross-coupling a hydroxyl-substituted aryl boronic acid and a halide BBB. (See FIG. 12A.) As noted above, one portion of this phenol-substituted BOS is deprotected to form a phenol-substituted aryl boronic acid and another portion is triflated to form a phenyl triflate-substituted BOS. The phenol-substituted aryl boronic acid and the phenyl triflate-substituted BOS are cross-coupled which induces carbon-carbon bond formation between the aryl moiety of the phenol-substituted aryl boronic acid and the aryl moiety of the phenyl triflate-substituted BOS to form a protected, phenol-substituted polyarene intermediate.

Subsequent IBS steps (e.g., m=2) comprise using the protected, phenol-substituted polyarene intermediate formed from a previous IBS step (e.g., m=1) as the phenol-substituted BOS to form another phenol-substituted aryl boronic acid and another phenyl triflate-substituted BOS, which are cross-coupled to form another protected, phenol-substituted polyarene intermediate.

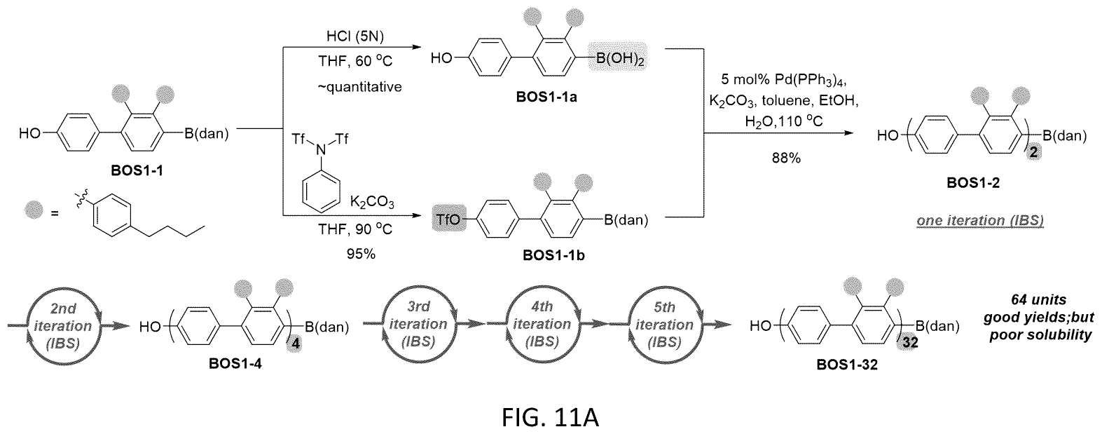

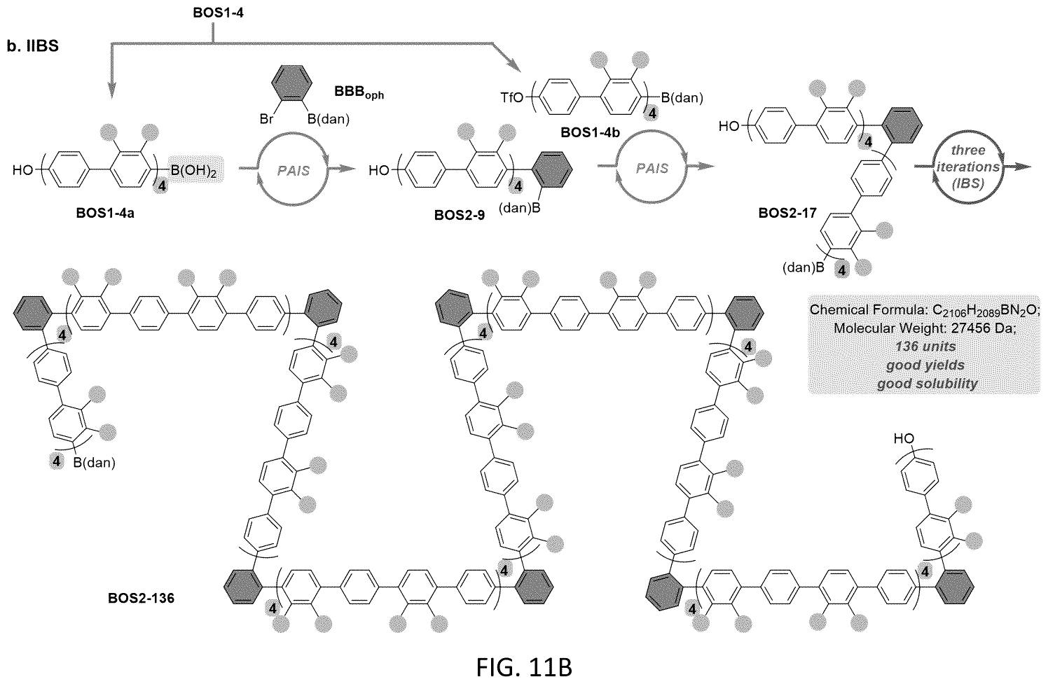

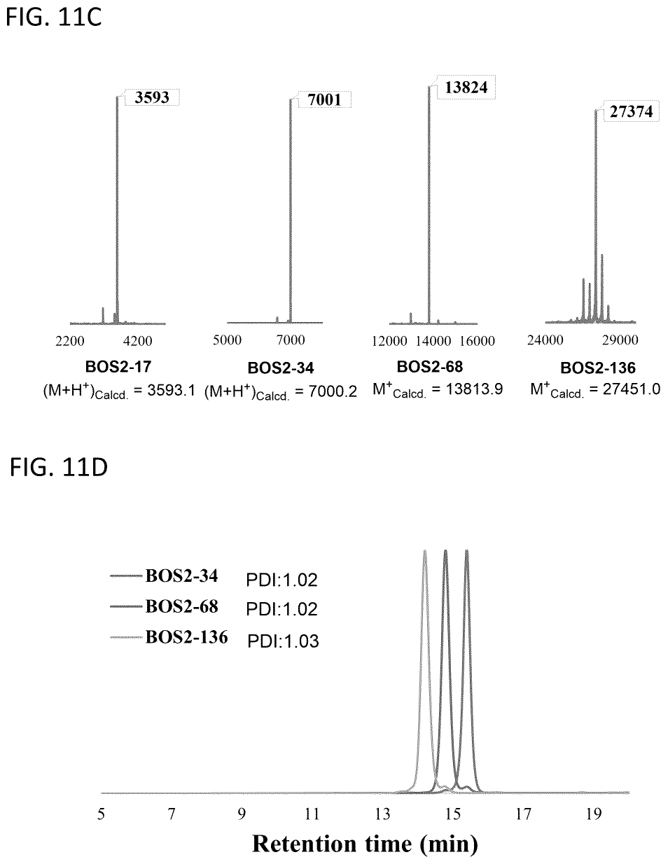

By way of illustration and in reference to FIG. 11A (and see FIGS. 12A-12C), an initial IBS uses “BOS1-1” as an initial phenol-substituted BOS to provide “BOS1-1 a” (after deprotection) as an initial, or first, phenol-substituted aryl boronic acid and “BOS1-1b” (after triflation) as an initial, or first, phenyl triflate-substituted BOS. Then, “BOS1-1 a” and “BOS1-1b” are cross-coupled to provide “BOS1-2” as the initial, or first, protected, phenol-substituted polyarene intermediate. A second IBS step uses “BOS1-2” as the phenol-substituted BOS to provide “BOS1-2a” (after deprotection) and “BOS1-2b” (after triflation), which are cross-coupled to provide “BOS1-4” as a second protected, phenol-substituted polyarene intermediate. A third IBS step uses “BOS1-4” as the phenol-substituted BOS to provide “BOS1-4a” (after deprotection) and “BOS1-4b” (after triflation), which are cross-coupled to provide “BOS1-8” as the third protected, phenol-substituted polyarene intermediate, etc. This method is further described in Example 2, below.

Although not shown in FIG. 11A or FIG. 12C, the final protected, phenol-substituted polyarene intermediate “BOS1-32” may be deprotected and cross-coupled with an endcapper to form a GNR precursor. Similarly, the GNR precursor may be subjected to conditions to induce cyclodehydrogenation to form a GNR. Here, the deprotection, cross-coupling, endcapper, and cyclodehydrogenation are analogous to the description provided above with respect to the PAIS steps.

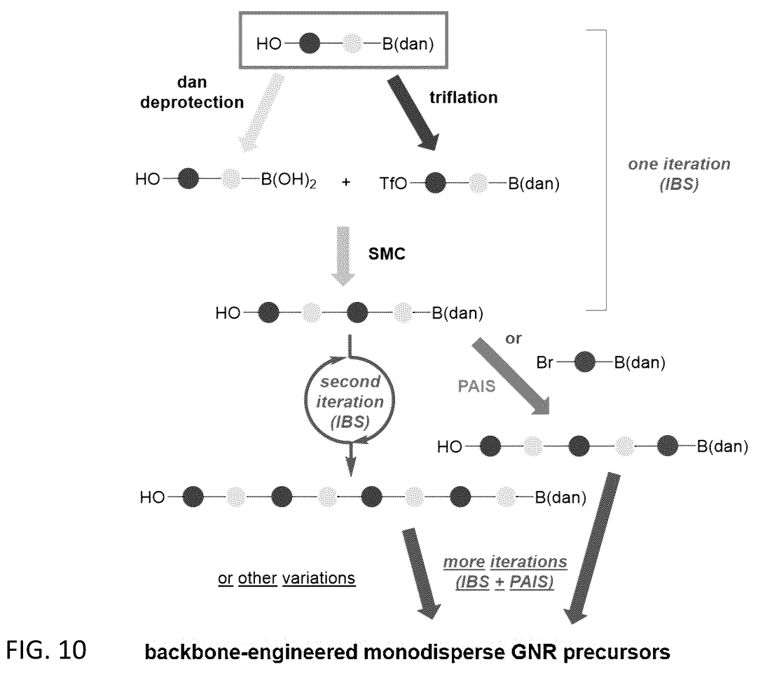

Although the present methods may comprise only PAIS steps to fabricate a GNR, or only IBS steps to fabricate a GNR, in embodiments, these steps are both used. In such embodiments, the PAIS steps and the IBS steps may be performed in any desired sequence, e.g., one or more IBS step(s) first, one or more PAIS step(s) next, and finally, one or more IBS step(s). Methods comprising both PAIS steps and IBS steps may be referenced using the phrase “integrated iterative binomial synthesis (IIBS).” Such methods are particularly useful to fabricate long, high molecular weight GNRs. FIG. 10 is a schematic illustrating IIBS.

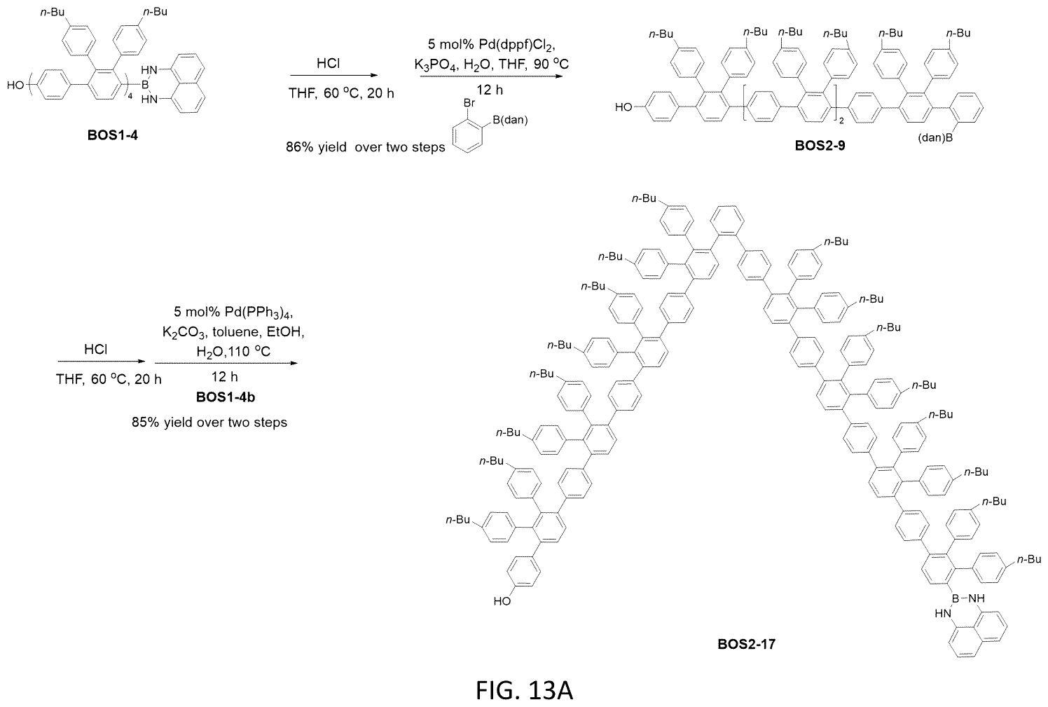

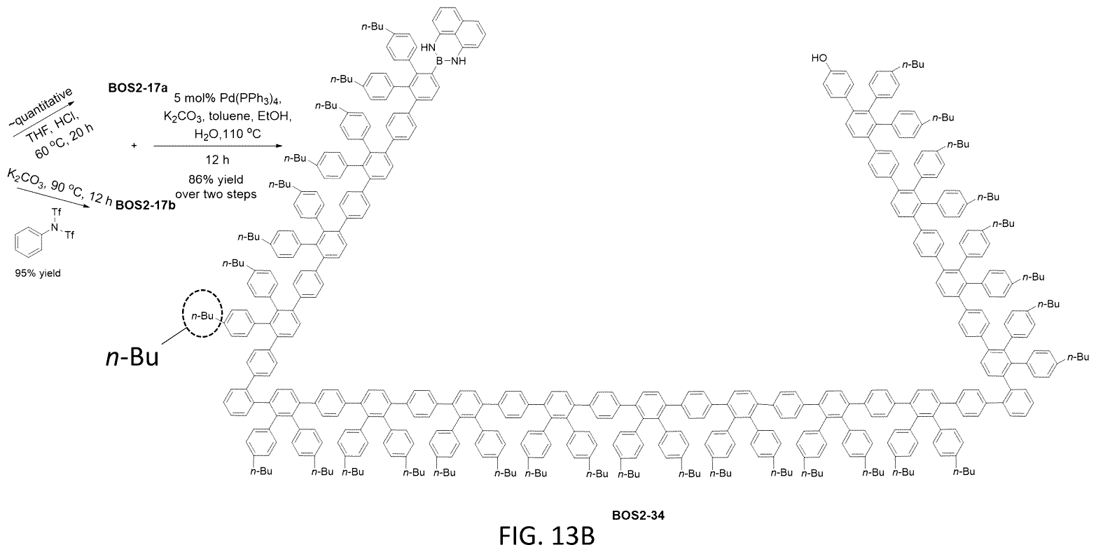

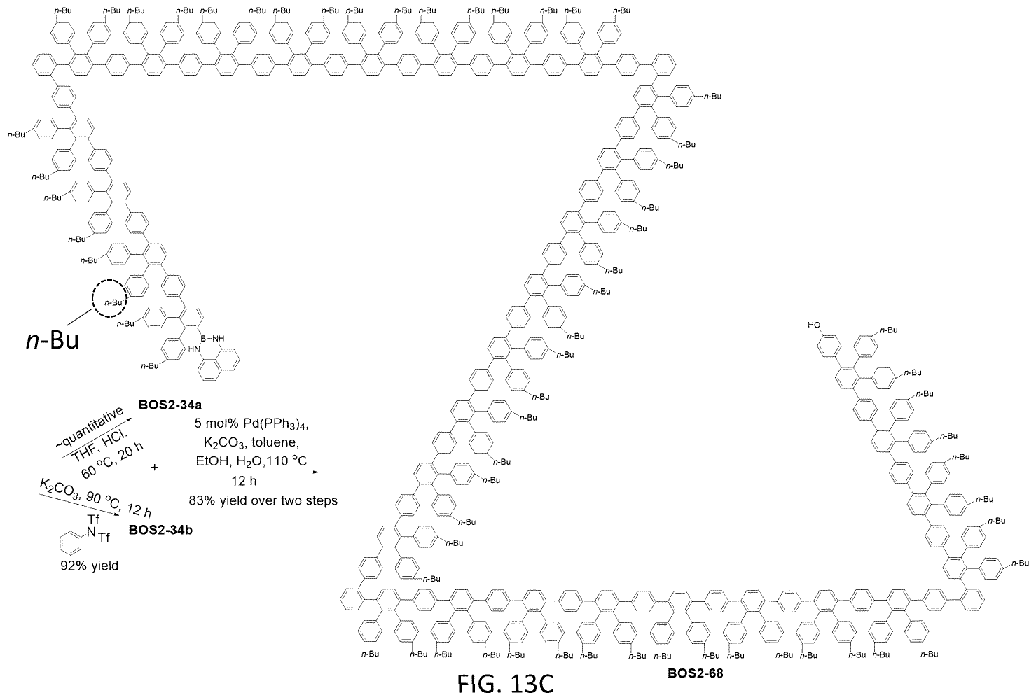

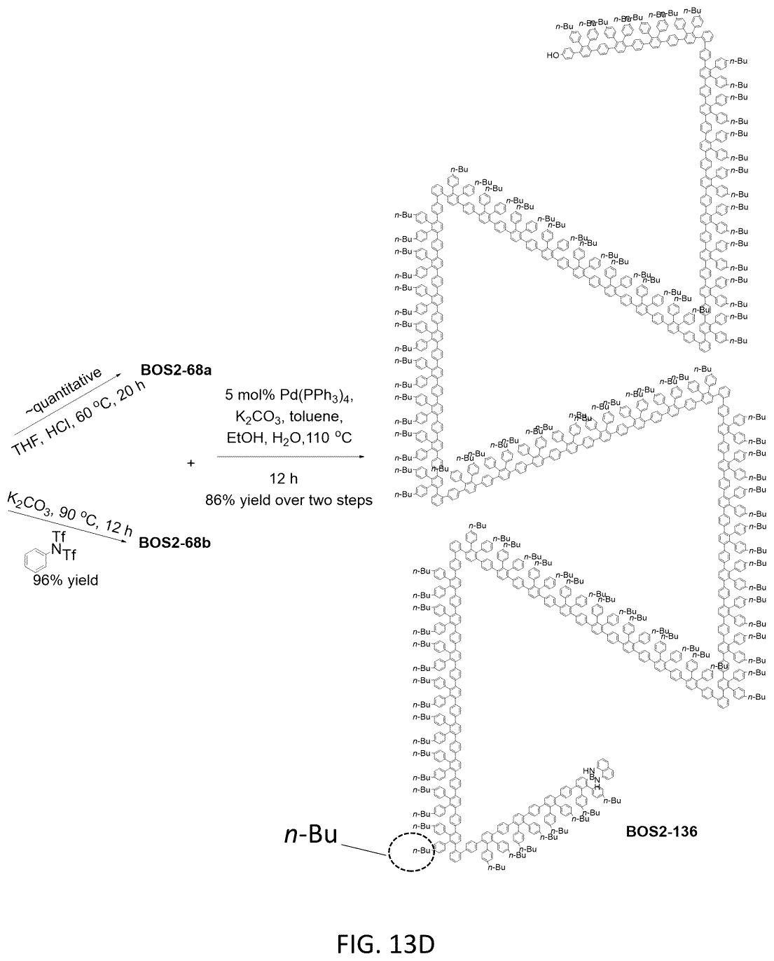

By way of illustration and in reference to FIG. 11B (and see FIGS. 13A-13D), two iterations (i.e., m=2) of IBS steps are carried out to form “BOS1-4” as a protected, phenol-substituted polyarene intermediate. Next, one portion of “BOS1-4” is deprotected to provide “BOS1-4a” (a phenol-substituted aryl boronic acid) and another portion is triflated to provide “BOS1-4b” (a phenyl triflate-substituted BOS). However, instead of cross-coupling “BOS1-4a” and “BOS1-4b”, a first PAIS step is carried out using “BOS1-4a” as the aryl boronic acid and a halide BBB (“BBBₒₚₕ”) to provide “BOS2-9” (a protected polyarene intermediate), which is deprotected to provide a deprotected polyarene intermediate. A second PAIS step is carried out using this deprotected polyarene intermediate as the aryl boronic acid and “BOS1-4b” as a triflated BBB to provide “BOS2-17” (a protected polyarene intermediate). Next, another IBS step is carried using “BOS2-17” as the phenol-substituted POS to provide “BOS2-17a” (after deprotection) and “BOS2-17b” (after triflation), which are cross-coupled to provide “BOS2-34” as another protected, phenol-substituted polyarene intermediate. Two additional IBS steps are carried out to provide “BOS2-136” as the final protected, phenol-substituted polyarene intermediate.

This IIBS embodiment illustrates that PAIS steps may make use of phenol-substituted aryl boronic acids and phenyl triflated-substituted BOSs formed from IBS steps as the aryl boronic acids and the triflated BBBs, respectively.

Although not shown in FIG. 11B or FIG. 13D, the final protected, phenol-substituted polyarene intermediate “BOS2-136” may be deprotected and cross-coupled with an endcapper to form a GNR precursor. Similarly, the GNR precursor may be subjected to conditions to induce cyclodehydrogenation to form a GNR. Here, the deprotection, cross-coupling, endcapper, and cyclodehydrogenation are analogous to the description provided above with respect to the PAIS steps.

A description of the various chemical moieties from which the various chemical compounds (e.g., aryl boronic acids, BBBs, phenol-substituted BOSs, phenol-substituted aryl boronic acids, phenyl triflate-substituted BOSs, endcappers, etc.) are composed is provided below. It is noted that, depending upon the particular PAIS step, IBS step, or substep therein, some of the chemical compounds may be composed of some of the same type of moieties (e.g., a phenol-substituted BOS that comprises the same type of aryl moiety as the phenol-substituted aryl boronic acid and the phenyl triflate-substituted BOS). (“Type” refers to a specific chemical such that “same type” means the same chemical and “different type” means different chemicals.) However, other of the chemical compounds may be composed of some different types of moieties (e.g., a halide BBB that comprises a different type of aryl moiety from that of a different halide BBB). Below, “-” refers to the covalent linkage (which may be a direct covalent linkage) between the moiety and the rest of the chemical compound in which the moiety is incorporated.

An “aryl moiety” refers to both a monocyclic aryl moiety having one aromatic ring (e.g., a phenyl moiety) and a polycyclic moiety having more than one aromatic ring (e.g., two, three, four, five, six, seven, eight, nine, ten, etc. rings). A monocyclic aryl moiety may be unsubstituted, by which it is meant the monocyclic aryl moiety contains no heteroatoms (i.e., non-carbon/non-hydrogen atoms). However, an unsubstituted monocyclic aryl moiety encompasses a monocyclic aryl moiety in which one or more bonds to a carbon(s) or hydrogen(s) are replaced by a bond to an unsubstituted hydrocarbon moiety (e.g., unsubstituted alkyl moiety, etc.). The monocyclic aryl moiety may be substituted, by which it is meant an unsubstituted monocyclic aryl moiety in which one or more bonds to a carbon(s) or hydrogen(s) are replaced by a bond to a non-carbon/non-hydrogen atom, e.g., N, O, S, etc.

Regarding polycyclic moieties, neighboring aromatic rings may be fused or unfused. Neighboring unfused aromatic rings may be joined together directly via a covalent bond. The aromatic rings of a polycyclic moieties may be unsubstituted or substituted as described above with respect to monocyclic aryl groups.

An “aryl moiety” may be represented as “—Arⁿ—” wherein n is an integer used to identify distinct aryl moieties, which may be the same type or different types from one another. Alternatively, as shown in FIG. 6A, alphabetic letters may be used to represent aryl moieties, wherein different letters generally represent different types of aryl moieties.

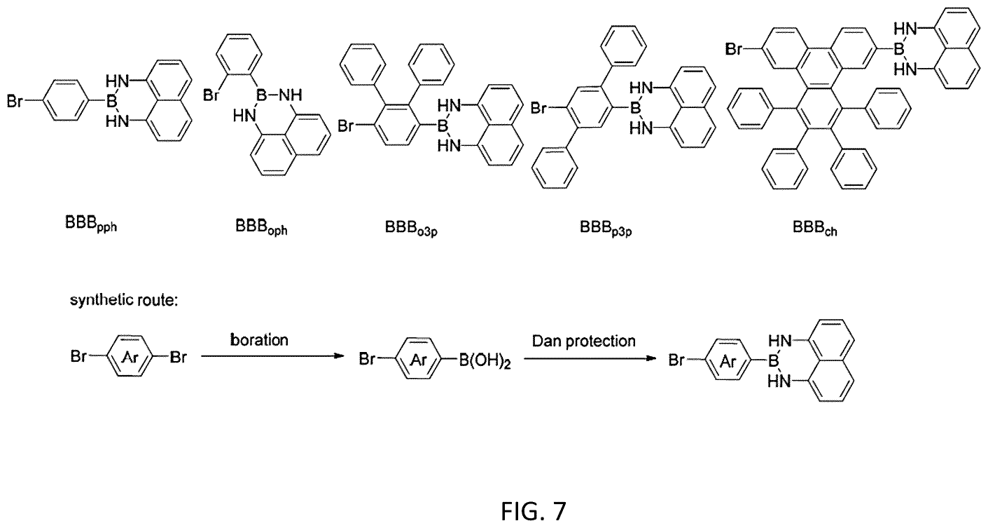

Any substituents of an aryl moiety (or a phenyl moiety thereof) may be in an ortho, meta, or para position (e.g., compare the ortho-terphenyl moiety of “BBB₀₃ₚ” and the para-terphenyl moiety of “BBBₚ₃ₚ” in FIG. 7). Similarly, any other moiety (e.g., halide moiety, protected boronic acid moiety) covalently linked to an aryl moiety (or a phenyl moiety thereof) may be in the ortho, meta, or para position (e.g., compare the halide and protected boronic acid moieties covalently bound to the phenyl moiety of “BBBₚₚₕ” and of “BBBₒₚₕ” in FIG. 7).

Illustrative aryl moieties include phenyl; terphenyl (encompassing ortho-, meta-, and para-terphenyl); 1,2,3,4-Tetraphenyltriphenylene; and 4,4″ -dibutyl-1,1′:2′,1″-terphenyl. (See the aryl moieties in the halide BBBs of FIG. 7 and of the phenol-substituted BOS “BOS1-1” of FIG. 12A.)

A “halide moiety” may be represented as “—X”, wherein X is a halide, e.g., Br.

A “phenyl triflate moiety” may be represented as —(C₆H₅)OSO₂CF₃. The triflate moiety (—OSO₂CF₃) may be covalently bound to the phenyl moiety (—C₆H₅) in an ortho, meta, or para position.

A “protected boronic acid moiety” may be represented as —B(PG), wherein B is boron and PG is a protecting group moiety. The protecting group moiety depends upon the protecting group used to covalently bond to the boron. In embodiments, the protecting group is 1,8-diaminonaphthalene. The protecting group moiety derived from 1,8-diaminonaphthalene may be represented as “dan.” A “boronic acid moiety” or “deprotected boronic acid moiety” may be represented as —B(OH)₂.

The present disclosure also encompasses any of the GNR precursors and GNRs fabricated using the present methods, including compositions and devices incorporating the same. As demonstrated in the Examples, below, the GNR precursors are highly monodisperse. Monodispersity may be quantified using MALDI-TOF mass spectra as described in the Examples below. A monodisperse GNR precursor exhibits a MALDI-TOF mass spectrum having peaks corresponding to a calculated molecular weight. The calculated molecular weight is determined based on the total number of PAIS and IBS steps used and the particular chemical compounds used in each such step. (See, e.g., FIGS. 2D, 3D, 4A, 5A, and 6A.) Monodispersity may also be quantified using GPC to measure a polydispersity (PDI) index as described in Example 2, below. A monodisperse GNR precursor is characterized by a PDI index of no more than 1.02, no more than 1.03, no more than 1.04, no more than 1.05 or in a range of from 1.02 to 1.05. The high monodispersity of the present GNR precursors translates to increased monodispersity of the GNRs fabricated therefrom. The monodispersity of the present GNR precursors and GNRs is by contrast to exiting techniques for fabricating GNRs which are limited by producing polydisperse GNRs.

The present GNRs are narrow strips of graphene having a particular chemical composition, size, and morphology determined by (and thus, fully controllable by) selecting a particular total number of PAIS and IBS steps and the particular “monomers” (e.g., BBBs and BOSs) used in each such step. Although heteroatoms may be present, the GNRs are otherwise composed of a monolayer of carbon atoms arranged in a hexagonal lattice structure as in graphene. This does not preclude some stacking of phenyl moieties between GNRs (or portions thereof), although the Examples below demonstrate that such stacking is minimal or non-existent. Thus, the GNR thickness (taken as the dimension perpendicular to a plane defined by the GNRs) is very small, e.g., no more than 2 nm, no more than 1 nm, or no more than 0.5 nm. The GNR length depends upon the total number of PAIS and IBS steps and the particular monomers used in each step, but very long GNRs may be fabricated, e.g., at least nm, at least 15 nm, at least 20 nm, at least 25 nm, at least 50 nm, or in a range of from 3 nm to 50 nm. GNR length may be measured along the backbone of the GNR, which may be defined by connecting the covalent linkages formed between monomers, e.g., see the labeled dotted line in FIGS. 4A and 5A. GNR length may also be indicated by reference to the number of phenyl moieties incorporated along the GNR backbone. In embodiments, at least at least 25, at least 50, at least 75, at least 100 phenyl moieties, at least 130 phenyl moieties, or in a range of from 10 to 136 phenyl moieties are incorporated. The GNR width also depends upon the total number of PAIS and IBS steps and the particular monomers used in each step, but the GNR width is generally less than its length. The width may be taken as the dimension perpendicular to the backbone, within the plane defined by the GNR. The GNR width may be no more than 10 nm, no more than 5 nm, no more than 2 nm, or no more than 1 nm.

The dimensions referenced in the paragraph above may be average values as determined from a representative number (e.g., 25, 50, 100, etc.) GNRs in a composition comprising the GNRs. STM images may be used to measure the dimensions.

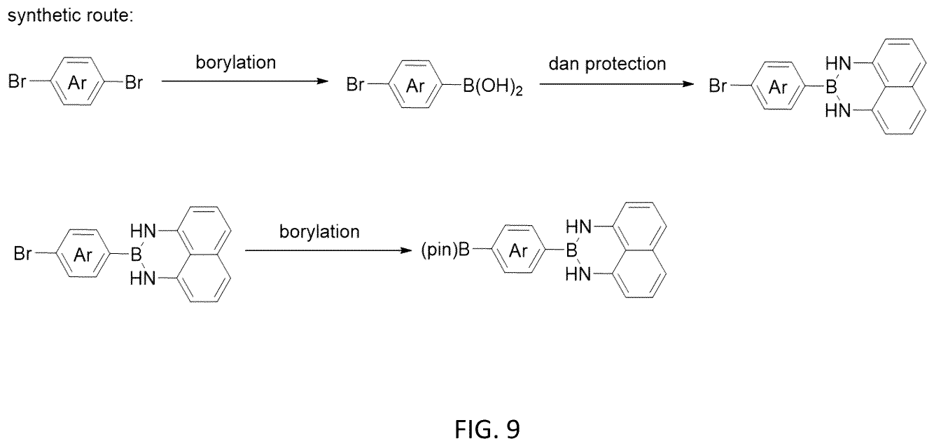

The GNRs may also be characterized by the different types of aryl moieties incorporated therein, as derived from different types of monomers used. This is by contrast to existing techniques for fabricating GNRs which are limited to incorporating two types of monomers. In embodiments, the GNR comprises at least three different types of aryl moieties, e.g., see 6-V-6-AGNR in FIG. 5A and 9-V-chGNR in FIG. 6A. However, the number of different types of aryl moieties used is not particularly limited.

The morphology, i.e., overall shape of the GNRs, also depends on the total number of PAIS and IBS steps and the particular monomers used in each such step. However, embodiments of the present methods produce uniquely shaped GNRs, including “kinked” GNRs. Rather than having straight backbones, kinked GNRs have bent backbones due to the presence of one or more “kinks” therein. These kinks may be achieved by using certain monomers, e.g., those comprising ortho-substituted aryl moieties. By way of illustration, the halide BBB “BBBₒₚₕ” was used to provide kinked GNRs, including 6-V-6-AGNR (FIG. 5A) and 9-V-chGNR (FIG. 6A). See also the kinked GNR precursor BOS2-136 in FIGS. 11B and 13D. Existing techniques for fabricating GNRs cannot controllably provide kinked GNRs.

Also encompassed by the present disclosure are chemical synthesis systems configured to carry out any of the disclosed methods. Such systems may include a controller configured to control one or more components of the system. The controller may include an input interface, an output interface, a communication interface, a computer-readable medium, a processor, and an application. The computer-readable medium may have computer-readable instructions stored thereon that, when executed by the processor of the controller, cause the system to carry out any of the disclosed methods in order to fabricate a GNR.

### EXAMPLES

### Example 1

### Introduction

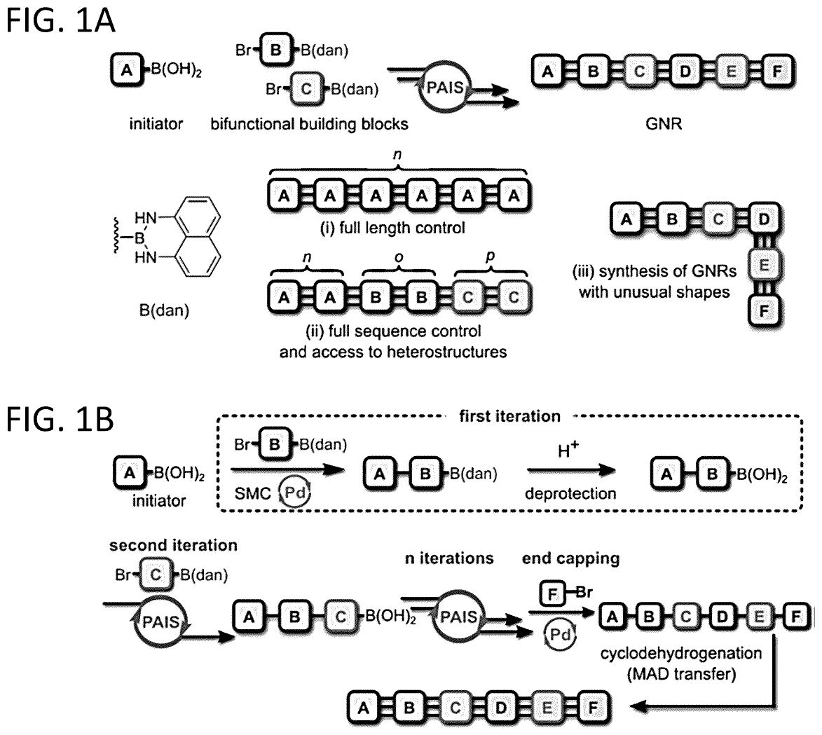

This Example describes the development of a general fabrication method for preparing diverse GNR structures assembled from multiple types of monomers and for yielding precisely controlled GNR sequence, length, and shape. The method is based on a protecting-group-aided iterative synthesis (PAIS) strategy (FIG. 1A). The PAIS strategy involves an iterative process of using solution-mediated cross-coupling and deprotection to generate desired GNR oligomer sequences by adding a single monomer to the chain per chemical cycle. The final step of the GNR synthesis is accomplished by performing matrix-assisted direct (MAD) transfer of the GNR oligomers onto a metal surface and subsequent on-surface cyclodehydrogenation (CDH). Scanning tunneling microscopy (STM) characterization and matrix-assisted laser desorption/ionization—time-of-flight (MALDI-TOF) spectroscopy reveal that the desired GNRs are produced in almost fully monodisperse fashion in each synthesis, and bond-resolved STM (BRSTM) unequivocally shows the GNRs to be the intended targets with the correct monomer sequence. The results show that PAIS enables synthesis of GNRs with controlled length, controlled heterostructure sequence, and novel (e.g., kinked) designer shapes.

### Experimental

### General Remarks

NMR spectra were recorded on a Bruker Model DMX 400. The ¹H NMR (400 MHz) chemical shifts were recorded relative to CDCl₃ as the internal reference (CDCl₃: δ_{H}=7.26 ppm;). The ¹³ C NMR (101 MHz) chemical shifts were given using CDCl₃ as the internal standard (CDCl₃: δ_{C}=77.16 ppm). Data for ¹H, ¹³ C NMR were recorded as follows: chemical shift (δ, ppm), multiplicity (s=singlet, d=doublet, dd=doublet of doublets, t=triplet, m=multiplet). High-resolution mass spectra (HRMS) were obtained on an Agilent 6530 LC Q-TOF mass spectrometer using electrospray ionization with fragmentation voltage set at 115 V and processed with an Agilent MassHunter Operating System. Matrix-assisted laser desorption/ionization—time-offlight (MALDI-TOF) mass spectra were obtained on a Bruker Ultraflextreme MALDITof-Tof instrument in Reflection mode or linear mode, using 2,5-dihydroxybenzoic acid (DHB) as matrix or without using matrix. IR spectra experiments were conducted on a on a Nicolet 380 FTIR using neat thin film technique. All STM experiments were carried out using a commercial CreaTec LT-STM held at T=4.5 K using platinum—iridium tips. Image processing of the STM scans was performed using WSxM software. Tip passivation was performed using standard procedures. Bond-resolved STM experiments were performed in constant-height mode, with the use of a lock-in amplifier, using a wiggle voltage (Vac) of 20 to 40 mV at a frequency (f) of 533.3 Hz.

Unless otherwise noted, all reagents were obtained from commercial suppliers and used without further purification. Pd(dppf)Cl₂ and Pd(PPh₃)₄ were prepared according to known procedures. The solvents were purified and dried using an Inert PSMD-7 Solvent Purification System. Unless otherwise noted, all reactions were performed with dry solvents under an atmosphere of nitrogen in a vial.

### Synthesis of Bifunctional Building Blocks (BBB)

FIG. 7 shows five bifunctional building blocks (BBB). FIG. 7 also shows a synthetic route to such BBBs, illustrated using BBBₚₚₕ.

### General Procedure for the Borylation of Dibromoaromatics

Dibromoarene substrates were obtained following known procedures. Then, the dibromoarene substrate (10 mmol) was dissolved in dry THF (50 mL) under N₂, and the solution was cooled down to −78° C. n-BuLi (2.5M, 1.2 equivalents) was added dropwise and the mixture was stirred at −78° C. for 1 h. Then, to the reaction mixture, triisopropyl borate (1.5 equivalents) was added dropwise. The resulting mixture was stirred at room temperature overnight before HCl (1 M in H₂O, 30 mL) was added. The mixture was extracted with ethyl acetate three times. The obtained organic phase was washed with water three times. The solvent of the organic phase was removed to give the aryl boronic acid, which was directly used in the dan protection scheme without further purification.

### General Procedure for the Dan Protection

Following known procedures, the aryl boronic acid substrate (10 mmol), 1,8-diaminonaphthalene (11 mmol) and toluene (20 mL) were added in a vial under air and the mixture was refluxed at 120° C. for 12 h. After the reaction was completed, the solvents were removed by rotary evaporation and the residue was purified by silica gel chromatography using hexanes/DCM (5:1) as the eluent to give the desired B(dan) product.

Some bifunctional building blocks, e.g., BBBₚₚₕ and BBBₒₚₕ, can be obtained via dan protection of the corresponding commercially available aryl boronic acids.

General Procedure for Protecting-group-aided Iterative Synthesis (PAIS)

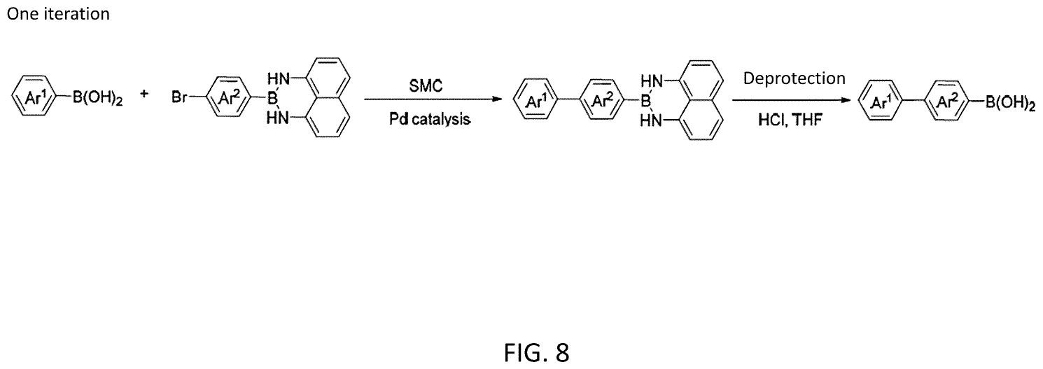

FIG. 8 shows one operative iteration of PAIS, illustrated using phenylboronic acid and BBBₚₚₕ.

### General Procedure A for the SMC Step

The coupling partners (the aryl boronic acid and the BBB), [1,1′-bis(diphenylphosphino)ferrocene]dichloropalladium(II) complex (1 mol %), anhydrous K₃PO₄ (4 equiv.), H₂O (7 equiv.) and dry THF (0.1 M) were added in a vial in glovebox. For the first step, the ratio of aryl boronic acid and BBB was 1.2:1; the ratio was switched to 1:1.2 for all the rest steps. The reaction was heated to 90° C. or 110° C. for 12 h. The solvent was removed under reduced pressure. The residue was purified by column chromatography on silica gel to provide the desired product.

### General Procedure B for the SMC Step

The coupling partners, tetrakis(triphenylphosphine)palladium (2 mol %), K2CO3 (4 equiv.) and toluene/ethanol/H20 (4:1:1) were added in a vial in glovebox. The ratio of aryl boronic acid and BBB was 1:1.2. The reaction was heated to 110° C. for 12 h. The solvent was removed under reduced pressure. The residue was purified by column chromatography on silica gel to provide the desired product.

### General Procedure for the Deprotection

A vial was charged with B(dan) product (1 mmol) under air. The vial was then transferred to a glovebox, before HCl (5 M in H₂O, 30 equiv.) and dry THF (10 mL) was added. The vial was taken out of glovebox and the reaction was stirred at 60° C. for 20 h. The mixture was extracted by EtOAc three times. The organic phases were combined and washed with water at least six times. After the solvents were removed by rotary evaporation, the residue was used directly in the next coupling reaction.

During the synthesis of oligomer GNR precursors, the B(dan) intermediates of the first several steps can be characterized by NMR. Those in the last few steps were only characterized by MALDI-TOF-MS spectroscopy, due to their poor solubility in common NMR solvents.

General procedure for preparation of MAD transfer samples: The GNR precursor to be deposited was combined with pyrene at room temperature in a vial to make a 0.1 wt % mixture of sample in pyrene under N₂ atmosphere. The vial was then heated to 180° C. and the melted mixture swirled for 5 min to ensure homogeneous dispersion of the GNR oligomer precursors in the pyrene melt. The melted mixture was then immediately placed into an acetone/dry ice bath to induce rapid crystallization. The obtained solid was then ground to a fine powder prior to deposition.

Sample preparation: Atomically clean Au(111) on mica was prepared through repeated cycles of argon ion (Ar⁺) bombardment and annealing. Oligomer GNR precursors were introduced onto the surface through matrix-assisted direct (MAD) transfer using the setup described in McCurdy, R. D. et al. J. Am. Chem. Soc. 143, 4174 (2021). In each MAD transfer experiment, the glass fiber was cleaned with solvents and subsequently outgassed in high vacuum (p<10⁻⁷ mbar) at T=500° C. for t=30 min prior to MAD transfer. It was then removed from the vacuum chamber and the MAD powder was applied to it under ambient conditions. The fiber was then reintroduced into the chamber and the powder transferred onto the surface under vacuum by gently touching the clean gold surface until a barely visible amount of material was observed by eye. After MAD transfer, the Au(111) samples were heated to T₁=80° C. for t=10 hr, and then to T=270° C. for t=10 min, in order to sublimate the pyrene matrix and to promote surface diffusion of the polymers. A higher-temperature anneal to T₂=360° C. for t=20 min was performed on all samples to induce cyclodehydrogenation.

STM measurements: All STM experiments were carried out using a commercial CreaTec LTSTM held at T=4.5 K using platinum-iridium tips. Image processing of the STM scans was performed using WSXM software. Tip passivation was performed using standard procedures. Bond-resolved STM experiments were performed in constant-height mode, with the use of a lock-in amplifier, using a wiggle voltage (V_{ac}) of 20 to 40 mV at a frequency 0 of 533.3 Hz.

### Results and Discussion

Strategy development. As shown in FIG. 1B, the PAIS strategy involves the use of bifunctional building blocks (BBBs) containing a halide and a masked boronic acid to achieve controlled iterative couplings. 1,8-diaminonaphthalene (dan) was used to protect the boronic acid group [B(dan)] of the BBBs. The dan protecting group is stable and unreactive under SMC conditions and can be readily deprotected to reveal the reactive boronic acid moiety upon treatment with an acid. As shown in FIG. 1B, a BBB containing both a bromo and B(dan) substituent first couples with an initiating monomer (i.e., the “initiator”) that only contains a boronic acid via SMC. Next, acid hydrolysis of the B(dan) moiety is performed to deprotect the boronic acid, activating it for the next cross-coupling step. The resulting boronic acid intermediate could then be cross-coupled with the second (either the same or different) BBB for chain propagation. In this PAIS process the SMC and acid hydrolysis constitutes one operative iteration, and only one GNR monomer is introduced to the chain per iteration. This is the key to realizing programmability and length/sequence control. The GNR polymer or oligomer chain can be terminated at any stage by SMC with an end-capping monomer (i.e., endcapper) that only contains a bromo group. The final GNR product is then obtained through cyclodehydrogenation (CDH), either in solution or on-surface.

Length control. To evaluate the PAIS strategy, chevron-type GNRs with exactly six repeating units were fabricated (FIG. 2A). Phenylboronic acid was used as the initiator and six iterations of solution-based cross-coupling/hydrolysis were performed using a chevron-type bifunctional building block (BBB_{ch}) (B in FIG. 2A). (BBB_{ch} is 2-(7-bromo-9,10,11,12-tetraphenyltriphenylen-2-yl)-2,3-dihydro-1H-naphtho[1,8-de] [1,3,2]diazaborinine.) The BBB_{ch} was prepared via borylation of the corresponding dibromo monomers and protection of the resulting boronic acid moiety with dan. SMC was realized in high yield with 1 mol % Pd(dppf)Cl₂ as catalyst, anhydrous potassium phosphate as base, H₂O as additive, and tetrahydrofuran (THF) as solvent. In each SMC step, one chevron-type bifunctional building block was added to the oligomer. Because the BBB contains an unreactive B(dan) group, no further coupling occurred afterwards. Hydrolysis was realized with 5 M HCl under N₂ atmosphere at 60° C., and the corresponding boronic acid was purified via extraction with ethyl acetate. This deprotection step turned the unreactive B(dan) terminus into reactive B(OH)₂, effectively activating it for the next coupling rection with another BBB. The two-step SMC-deprotection process was iterated a total of six times to introduce six chevron repeating units, and the synthesis of the oligomer GNR precursor pre-chGNR(6) was completed by a terminating cross-coupling step, i.e., endcapping, using phenyl bromide as the endcapper.

With a monodisperse sample of pre-chGNR(6) now in hand, the final GNR product was obtained via the MAD transfer technique. (See McCurdy, R. D. et al.) Briefly, to accomplish MAD, the pre-chGNR(6) was first dispersed into a matrix of pyrene by dissolving at high temperature and performing homogenization, followed by rapid cooling and milling of the resulting solid into a fine powder. This mixture was then applied to a clean glass fiber installed in the preparation chamber of an ultra-high vacuum (UHV) STM system. The chamber was then pumped down to high vacuum and the mixture was applied to a pre-cleaned Au(111) surface. The Au(111) sample was then heated to T₁=80° C. for t=10 hr to sublime the pyrene matrix and induce diffusion of the polymers over the surface, followed by heating to T₂=360° C. for t=20 min to induce CDH of the oligomers into fully planar ch-GNR(6). The resulting GNRs were characterized via BRSTM imaging, revealing the precise expected structure as shown in FIG. 2B. Larger-scale STM scans (FIG. 2C) show a highly monodisperse sample of chevron-type GNRs. The supermajority (>80%) of GNRs observed on the surface have the expected chevron structure with exactly six repeating units. Some defects were seen, such as an occasional incomplete CDH, as well as an occasional phenyl ring ejection. The overall GNR structure, however, is consistent with the desired ch-GNR(6). The high monodispersity observed in the STM measurements was corroborated by MALDI-TOF mass spectra. As shown in FIG. 2D, mass spectra reveal peaks corresponding precisely to the desired molecular weights of the GNR oligomer precursor. This suggests that the phenyl ejection defects observed in the surface-cyclized GNRs were introduced during the CDH step and are not likely to be present in the GNR precursor.

Heterostructure control. The PAIS method can generate heterostructures with predefined monomer sequences of different building blocks in addition to precise length. To illustrate this feature, precise, monodisperse N=9 armchair/chevron GNR heterostructures were fabricated as shown in FIG. 3A. The synthesis used the same phenylboronic acid initiator as in FIG. 2A-2D, after which five repeating units ofpara-terphenylene were added through five successive SMC/deprotection cycles utilizing the para-terphenylene building block (BBBₚ₃ₚ) (C in FIG. 3A). Three chevron monomers (BBB_{ch}) (B in FIG. 3A) were then added to the chain afterwards, at which point the synthesis was completed by end-capping the oligomer with a phenyl bromide. The resulting oligomer (GNR) precursor (pre-9-chGNR) was then transferred to the gold surface via the MAD transfer protocol, after which CDH was performed to yield the final, fully planar 9-chGNR heterostructure.

FIG. 3B shows a BRSTM image of the final 9-chGNR with the exact, intended GNR structure. It was observed that this GNR heterostructure was prone to defect formation, such as phenyl ejection, upon on-surface CDH (FIGS. 3C, 3D). This was likely caused by the relatively free rotation ofparaterphenyl groups around the GNR axis, leading to undesired stacking between neighboring phenyl rings and subsequent cleavage under CDH conditions. Regardless of these defects, the backbone of each GNR on the surface clearly shows the intended structure, as seen in larger-scale STM scans (FIG. 3E). The MALDI-TOF mass spectra also revealed a set of sharp peaks at the intended molecular weights (FIG. 3F), indicating that the observed defect formation was likely a consequence of the CDH process.

In order to explore the effectiveness of the PAIS strategy to create precise nonperiodic GNR structures with multiple interfaces, a double heterojunction composed of two N=6 segments surrounding a single N=9 segment was fabricated (FIG. 4A shows a sketch of the intended structure). Polymers with ortho-terphenyl units can yield 9-AGNRs, thus it was hypothesized that an alternating sequence of the phenyl- and terphenyl units could cyclize into a 6-AGNR. To accomplish this, the ortho-terphenyl bifunctional building block (BBBₒ₃ₚ) (A in FIG. 4A) and para-phenylene building block (BBBₚₚₕ) (D in FIG. 4A) were first coupled in an alternating manner for two cycles, and subsequently, five BBBₒ₃ₚ were incorporated into the chain, followed by adding another BBBₚₚₕ and BBBₒ₃ₚ units. After end capping, the 6/9/6-AGNR heterojunction oligomer precursor (pre-6/9/6-AGNR), with 13 phenylene units in its backbone, was completed. FIG. 4B shows an STM image of the pre-6/9/6-AGNR oligomer precursors after MAD transfer to the surface (and before CDH). All GNR oligomers on the surface had the same structure, and in close-up images (FIG. 4B, inset) a one-to-one correspondence between the observed pattern of lobes and the expected pattern of phenyl groups was seen.

CDH of this sample was performed on-surface to create the intended 6/9/6-AGNR heterostructures. As illustrated by the BRSTM images in FIG. 4C, the 9-AGNR segment cyclized well but isomerization or “flip” defects in the 6-AGNR regions occurred during CDH on surface. In these isomeric structures, successive terphenyl units cyclized on opposite sides of the GNR axis after C—C σ bond rotation into conformationally isomeric forms of the oligomer. This was likely due to a slight steric repulsion between neighboring terphenyl units, which lowered the activation barrier for cyclization into the non-linear products. Nevertheless, the STM images of both cyclized and non-cyclized phases, as well as the MALDI-TOF mass spectra (FIG. 4A inset), show that precise sequence and length control was achieved by the PAIS strategy.

Kinked GNRs. Having established that the PAIS-based method can give access to length-controlled GNRs and precise sequence-defined GNR heterostructures, the potential of PAIS to generate GNRs with previously inaccessible shapes was investigated next. The starting hypothesis was that GNRs with controlled angular turns could be obtained by selecting a BBB that has the bromine and B(dan) substituents at an angle relative to each other (e.g., the bromine and B(dan) substituents in an ortho position on a phenyl moiety). “Kinked” GNRs may be identified by the presence of “V” units, with V representing the kink. As shown in FIG. 5A, a 6-V-6-AGNR was fabricated by merging the 6-AGNR scaffold (A and D in FIG. 5A) with an ortho-phenylene unit (BBBₒₚₕ) (E in FIG. 5A). The ortho linkage between the bromine and the B(dan) groups in BBBₒₚₕ introduced an abrupt 120° growth direction change. After synthesis the oligomer (GNR) precursor (pre-6-V-6-AGNR) was transferred onto Au(111) using MAD for CDH and STM imaging.

STM images (FIG. 5B) and MALDI-TOF mass spectra (FIG. 5A inset) corroborate the correct V-shaped scaffold of the GNR oligomer precursors produced using PAIS. FIG. 5C shows a large-scale image of monodisperse 6-V-6-AGNRs on Au(111) after CDH. Close-up BRSTM images can be seen in FIG. 5D, which confirm that nearly all GNRs found on the surface had the expected 120-degree kink in their backbone, as well as the correct sequence and length. Similar to what was observed in the synthesis of 6/9/6-AGNR heterostructures, conformational isomerization at the 6-AGNR segments also took place during the CDH stage, leading to flip defects.

Lastly, to show the full range of structural flexibility afforded by PAIS, the kinked structural motif was integrated into a two-component GNR heterostructure. This was accomplished by fabricating a kinked heterojunction using chevron and N=9 GNR building blocks. The new oligomeric precursor (pre-9-V-chGNR) was successfully prepared using the PAIS strategy (FIG. 6A), involving the use of four different BBBs (A is BBBₚₚₕ, B is BBB_{ch}, C is BBBₚ₃ₚ, and E is BBBₒₚₕ) FIGS. 6B and 6C show the GNR oligomer precursor after MAD deposition to the Au(111) surface. The chevron-GNR segments were in good agreement with previous images of regular chevron-GNR precursors, while the 9-AGNR segments appeared as bright lobes. FIG. 6D shows a large-scale image of the resulting monodisperse 9-V-chGNRs after CDH. The close-up BRSTM images in FIG. 6E show 120° kinked heterojunctions with a thick chevron arm bonded to a thinner N=9 arm. Phenyl ejection defects were visible (similar to what was seen for ch-GNR(6) and 9-chGNR) but the BRSTM images again confirmed that the GNRs exhibited the exact sequence and length intended.

### Conclusion

In conclusion, a programmable approach has been developed to fabricate structurally diverse monodisperse GNRs with predetermined length, shape, and monomer sequence. This approach was enabled by the PAIS strategy, as well as subsequent MAD-transfer and on-surface CDH. The effectiveness and precision of the approach were supported by BRSTM characterization of diverse GNR structures that could not be fabricated using more conventional GNR synthesis techniques. Although surface-induced CDH was used here to facilitate GNR characterization by STM, the PAIS strategy is not limited to on-surface synthesis. This technology may be used for scalable liquid-phase fabrication of longer and more complex monodisperse GNR structures.

Additional information for Example 1 may be found in U.S. provisional patent application No. 63/349,811 that was filed Jun. 7, 2022, the entire contents of which are incorporated herein by reference.

### Example 2

### Introduction

This Example describes an integrated iterative binomial synthesis (IIBS) strategy to enable backbone engineering of GNR precursors with precisely controlled lengths and sequences, as well as high molecular weights. (See FIG. 10.) The IIBS strategy capitalizes on the use of phenol as a surrogate for aryl bromide and represents the merge between protecting-group-aided iterative synthesis (PAIS) and iterative binomial synthesis (IBS). Long and monodisperse GNR precursors with diverse irregular backbones, which are inaccessible by conventional polymerizations, can be efficiently prepared by IIBS. The GNR precursors may be converted to GNRs via cyclodehydrogenation as described in Example 1.

### Experimental

### General Remarks

NMR spectra were recorded on a Bruker Model DMX 400 spectrometer. The ¹H NMR (400 MHz) chemical shifts were recorded relative to CDCl₃ as the internal reference (CDCl₃: δ_{H}=7.26 ppm). The ¹³C NMR (100 MHz) chemical shifts were given using CDCl₃ as the internal standard (CDCl₃: δ_{C}=77.16 ppm). High-resolution mass spectra (HRMS) were obtained on an Agilent 6530 LCQ-TOF mass spectrometer using electrospray ionization with a fragmentation voltage set at 115 V and processed with an Agilent MassHunter Operating System. IR spectra experiments were conducted on a on a Nicolet 380 FTIR using the neat thin film technique. Matrix-assisted laser desorption/ionization—time-of-flight (MALDI-TOF) mass spectra were obtained with a Bruker Ultraflextreme MALDI-Tof-Tof instrument in reflection mode or linear mode, with trans-2-[3-(4-tert-Butylphenyl)-2-methyl-2-propenylidene]malononitrile (DCTB) or terthiophene as the matrix, or without using a matrix. Size exclusion chromatography (SEC) for polymer molecular weight analysis (based on polystyrene standard) was carried out with an Agilent 1260 Infinity system (VWD UV detector) and two 300×7.5 mm ResiPore GPC columns eluted with THF (HPLC grade, Sigma-Aldrich). Flow rate was 1.0 mL/min and the column temperature was maintained at 35° C.

Unless otherwise noted, all reagents were obtained from commercial suppliers and used without further purification. Pd(dppf)Cl₂ and Pd(PPh₃)₄ were prepared according to known procedures. The solvents were purified and dried using an Inert PS-MD-7 Solvent Purification System. PdCl₂ was purchased from Sigma-Aldrich CO., Ltd. Unless otherwise noted, all reactions were performed with dry solvents under a nitrogen atmosphere in a vial.

### Synthesis of Bifunctional Building Blocks and Their Derivatives

FIG. 9 shows a synthetic route to BBBs (top) and borylated derivates thereof (bottom), illustrated using BBBₚₚₕ.

### General Procedure for the Borylation of Dibromoaromatics

The dibromoarene substrate (10 mmol) was dissolved in dry THF (50 mL) under N₂, and the solution was cooled down to −78° C. n-BuLi (2.5M, 1.2 equiv.) was added dropwise with stirring, and the mixture was stirred at −78° C. for 1 h. Then, triisopropyl borate (1.5 equiv.) was added dropwise with stirring. The resulting mixture was stirred at room temperature overnight before HCl (1 M in H₂O, 30 mL) was added. The mixture was then extracted three times with ethyl acetate. The combined organic phase was washed three times with water, dried over anhydrous Na₂SO₄, and concentrated under reduced pressure to give the aryl boronic acid, which was directly used in the dan protection without further purification.

### General Procedure for the Dan Protection

Aryl boronic acid substrate (10 mmol), 1,8-diaminonaphthalene (11 mmol) and toluene (20 mL) were added in a vial under air atmosphere, and the mixture was refluxed at 120° C. for 12 hours. After the reaction was completed, the solvent was removed by rotary evaporation, and the residue was purified by silica gel chromatography using hexanes/DCM as the eluent to give the desired B(dan) product.

### General Procedure for the Integrated Iterative Binomial Synthesis

### General Procedure A for the SMC

The coupling partners (aryl boronic acid and bifunctional oligomer segment), [1,1′-bis(diphenylphosphino)ferrocene]dichloropalladium(II) complex (5 mol %), anhydrous K₃PO₄ (4 equiv.), H₂O (7 equiv.) and dry THF (0.1M) were added to a vial in a glovebox. The ratio of aryl boronic acid to bifunctional oligomer segment was 1:1.1. The reaction was stirred at 90° C. for 12 h. The solvent was removed under reduced pressure. The residue was purified by column chromatography on silica gel to provide the desired product.

### General Procedure B for the SMC

The coupling partners (aryl boronic acid and bifunctional oligomer segment), tetrakis(triphenylphosphine)palladium (5 mol %), K2CO3 (4 equiv.) and a solvent mixture of toluene/ethanol/H₂O (4:1:1) were added to a vial inside a glovebox. Rhe ratio of aryl boronic acid to bifunctional oligomer segment was 1:1.1. The reaction was then stirred at 110° C. for 12 h. The solvent was removed under reduced pressure. The resulting residue was purified by column chromatography on silica gel to yield the desired product.

### General Procedure for the Deprotection

A vial was charged with the B(dan) compound (1 mmol) under air, and then transferred to a glovebox. After adding HCl (5 M in H₂O, 15 equiv.) and dry THF (10 mL), the vial was removed from the glovebox and the reaction was stirred at 60° C. for 20 h. The mixture was extracted with an EtOAc/hexane mixture (1:1) three times. The organic phases were combined and washed with water three times. When the polymers containing benzothiazole were used as the substrates, the organic phase should be washed with a 1M NaHCO₃ aqueous solution three times. After the combined organics were dried with Na₂SO₄ and concentrated by rotary evaporation, the residue was used as is in the next coupling reaction.

### General Procedure A for the Triflation

Triethylamine (1.2 equiv.) was added to a stirred solution of phenol substrate (1.0 equiv.) in dichloromethane (0.25 M) at 0° C. under air. Then, trifluoromethanesulfonic anhydride (1.1 equiv.) was added to this solution dropwise. The mixture was allowed to stir at room temperature for 4 hours, before it was concentrated under reduced pressure. The residue was purified by column chromatography on silica gel using DCM and hexane as eluent to provide the triflation products.

### General Procedure B for the Triflation

Phenol substrate (1.0 equiv.), N-phenyltrifluoromethanesulfonimide (1.2 equiv.), K₂CO₃ (3.0 equiv.) and dry THF (0.1M) were added to a vial in a glovebox. The vial was taken out of glovebox and the reaction was stirred at 90° C. for 12 h. The reaction mixture was concentrated under reduced pressure conditions. The residue was purified by column chromatography on silica gel using DCM and hexane as eluent to yield the triflated products.

### Results and Discussion

To realize the IIBS of structurally diverse GNR precursors, the idea of using phenol moieties as a surrogate for aryl bromides was conceived, which can be activated under orthogonal conditions to B(dan) moieties for cross couplings. A number of benefits of using phenols could be envisioned. First, phenol hydroxy groups can be efficiently converted to the corresponding triflates (OTO that possess similar reactivity as aryl bromides in the Pd-catalyzed cross couplings. In addition, phenol moieties typically do not react under both the SMC and the B(dan) deprotection conditions. Moreover, the activation process, i.e., triflation of phenols, is rapid, mild and chemoselective, thus tolerating a wide range of functional groups, including electron-rich and basic (hetero)arenes, as well as B(dan) groups. Furthermore, the retardation factor (Rt) of the two coupling partners and the resulting bifunctional oligomer segments (BOS) in each iteration is quite distinguishable, rendering a convenient purification process. FIG. 10 illustrates the IIBS strategy which merges IBS with PAIS to achieve GNR precursors with irregular and well-defined sequences.

An illustrative GNR precursor was synthesized as shown in FIGS. 11A-11D. First, the initial substrate (BOS1-1) was prepared via SMC of 4-hydroxyphenylboronic acid with n-butylated version of BBB₀₃ₚ (2-(6′-bromo-4,4″-dibutyl-[1,1′:2′,1″-terphenyl]-3′-yl)-2,3-dihydro-1H-naphtho[1,8-de][1,3,2]diazaborinine) to form BOS1-1 (4″-butyl-3′-(4-butylphenyl)-4′-(1H-naphtho[1,8-de][1,3,2]diazaborinin-2(3H)-yl)-[1,1′:2′,1″-terphenyl]-4-ol). (See also FIG. 12A.) Next, as shown in FIG. 11A (and see FIG. 12B), BOS1-1 was divided into two portions with a ratio of 1:1.1. The minor part was treated with HCl under N₂ atmosphere at 60° C. to give the boronic acid fragment via dan deprotection; the other part was treated with K₂CO₃ and N-phenyltrifluoromethanesulfonimide to convert the unreactive OH terminus into reactive OTf. Note that the high tolerance of B(dan) moieties under the triflation conditions is the key for the success of this strategy. SMC of these two coupling partners was realized to give BOS1-2 in high yield by using Pd(PPh₃)₄ (5 mol %) as the catalyst, K₂CO₃ (4 equiv) as the base, and toluene/EtOH/H₂O (4:1:1) as the solvent at 110° C. In each SMC step, the length of the oligomer is doubled; given that B(dan) is unreactive under the SMC conditions, no further coupling occurred afterwards, which completes one iteration of the IBS. Chain doubling of BOS1-2 was achieved in the second iteration, involving the parallel dan-deprotection and triflation, followed by the SMC, and the yields remain excellent. The same IBS iteration was repeated in a total of five times, affording the monodisperse conjugated polymer BOS1-32 with 64 phenylene units in the backbone and an estimated length of more than 20 nm. (See also FIGS. 12B-12C.) At this stage, further iteration is hindered as BOS1-32 exhibits poor solubility in common organic solvents, likely owing to chain aggregation.

To address the solubility issue and to introduce structural variety and previously inaccessible topology, as shown in FIG. 11B, the IIBS approach via merging PAIS and IBS was demonstrated next. (See also FIGS. 13A-3D.) From the BOS1-4 intermediate, the corresponding boronic acid (BOS1-4a) and triflate (BOS1-4b) was prepared as described above. However, instead of coupling these two fragments to form BOS1-8, a PAIS process, i.e., the chain homologation with an ortho-phenylene monomer (BBBₒₚₕ) and then triflated BOS1-4b, was employed to interrupt the IBS. As a result, a 120° kink was introduced to the backbone to give a V-shaped oligomer BOS2-9, which then served as a starting point to undergo three iterations of IBS to ultimately provide monodisperse GNR precursor BOS2-136 with a distinct backbone. The molecular weights of the corresponding BOSs in all iterations were confirmed by matrix-assisted laser desorption/ionization-time of flight mass spectrometry (MALDI-TOF-MS) (FIG. 11C) and end group analysis using ¹H NMRs (data not shown). GPC traces of BOS2-34, BOS2-68 and BOS2-136 indicate extremely narrow polydispersity indexes (PDIs), which are 1.02, 1.02 and 1.03 respectively (FIG. 11D). These results support the unimolecular nature of these polymers. It is noteworthy that good solubility remains even with the final polymer BOS2-136, likely because of the multi-kinked backbone, which represents a unique advantage of IIBS over IBS.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A method of fabricating a graphene nanoribbon (GNR), the method comprising:
(a) performing, n times, a protecting-group-aided iterative synthesis (PAIS) step; performing, m times, an iterative binomial synthesis (IBS) step; or both,
wherein the PAIS step comprises:
(i) cross-coupling an aryl boronic acid with a bifunctional building block (BBB), the BBB comprising a halide moiety or a phenyl triflate moiety; an aryl moiety; and a protected boronic acid moiety, under conditions to form a protected polyarene intermediate; and
(ii) deprotecting the protected polyarene intermediate to form a deprotected polyarene intermediate;
further wherein, the IBS step comprises:
(iii) subjecting a first portion of a phenol-substituted bifunctional oligomer segment (BOS), the phenol-substituted BOS comprising a phenol moiety, an aryl moiety, and a protected boronic acid moiety, to deprotection to form a phenol-substituted aryl boronic acid;
(iv) subjecting a second portion of the phenol-substituted BOS to triflation to provide a phenyl triflate-substituted BOS comprising a phenyl triflate moiety; the aryl moiety; and the protected boronic acid moiety; and
(v) cross-coupling the phenol-substituted aryl boronic acid and the phenyl triflate-substituted BOS to form a protected, phenol-substituted polyarene intermediate;
(b) cross-coupling a final deprotected polyarene intermediate with an endcapper to form a GNR precursor; and
(c) subjecting the GNR precursor to conditions to induce cyclodehydrogenation therein to form a GNR.

2. The method of claim 1, wherein step (a) comprises performing, n times, the PAIS step, and further wherein the BBB comprises the halide moiety.

3. The method of claim 2, wherein the deprotected polyarene intermediate from the n^{th} PAIS step is the final deprotected polyarene intermediate.

4. The method of claim 1, wherein step (a) comprises, performing, m times, the IBS step, and the method further comprises deprotecting the protected, phenol-substituted polyarene intermediate from the m^{th} IBS step to provide the final deprotected polyarene intermediate. The method of claim 1, wherein step (a) comprises both performing, n times, the PAIS step and performing, m times, the IBS step.

6. The method of claim 5, wherein at least one of the n PAIS steps uses at least one of the phenol-substituted aryl boronic acids from at least one of the m IBS steps as the aryl boronic acid in (i).

7. The method of claim 5, wherein at least one of the n PAIS steps uses at least one of the phenyl triflate-substituted BOSs from at least one of the m IBS steps as the BBB comprising the phenyl triflate moiety in (i).

8. The method of claim 5, wherein at least one of the n PAIS steps uses at least one of the phenol-substituted aryl boronic acids from at least one of the m IBS steps as the aryl boronic acid in (i); and further wherein, at least one of the n PAIS steps uses at least one of the phenyl triflate-substituted BOSs from at least one of the m IBS steps as the BBB comprising the phenyl triflate moiety in (i).

9. The method of claim 8, wherein at least one of the n PAIS steps uses at least one BBB comprising the halide moiety in (i). The method of claim 5, wherein the method further comprises deprotecting the protected, phenol-substituted polyarene intermediate from the m^{th} IBS step to provide the final deprotected polyarene intermediate.

11. The method of claim 1, wherein the protected boronic acid moiety of the BBB, the phenol-substituted BOS, and the phenyl triflate-substituted BOS is —B(dan).

12. The method of claim 1, wherein the cyclodehydrogenation is surface-assisted cyclodehydrogenation.

13. The method of wherein the GNR precursor is characterized by a polydispersity index of no more than 1.05.

14. The method of claim 13, wherein n is at least 5, m is at least 5, or m+n is at least 5. The method of claim 1, wherein the GNR comprises a backbone having at least 50 phenyl moieties.

16. The method of claim 1, wherein the aryl moieties of the BBB, the phenol-substituted BOS, and the phenyl triflate-substituted BOS are independently selected from phenyl; terphenyl; 1,2,3,4-Tetraphenyltriphenylene; and 4,4″-di butyl-1,1′:2′,1″-terphenyl.

17. The method of claim 1, wherein the GNR comprises at least three different types of aryl moieties incorporated in a backbone of the GNR.

18. The method of claim 1, wherein the GNR is a kinked GNR comprising one or more ortho-substituted aryl moieties incorporated in a backbone of the GNR.

19. A composition comprising a GNR comprising at least three different types of aryl moieties incorporated in a backbone of the GNR. The composition of claim 19, wherein the GNR is a kinked GNR comprising one or more ortho-substituted aryl moieties incorporated in the backbone of the GNR.
